(19) United States
(12) Patent Application Publication
(10) Pub. No.: US 2026/0322239 A1
(43) Pub. Date: Oct. 15, 2026

(54) SYSTEMS AND METHODS FOR CONTROL OF NETWORKED POWER CONVERTERS

(71) Applicants: TAU MOTORS, INC., Redwood City, CA (US); THE TRUSTEES OF COLUMBIA UNIVERSITY IN THE CITY OF NEW YORK, New York, NY (US)

(72) Inventors: Walter Wesley PENNINGTON, III, Menlo Park, CA (US); Matthias PREINDL, New York, NY (US); Noah Hillock SILVERMAN, New York, NY (US); Ethan Bagget SWINT, Redwood City, CA (US); Gregory Gordon STEVENSON, San Carlos, CA (US)

(21) Appl. No.: 19/484,268

(22) PCT Filed: May 17, 2024
(86) PCT No.: PCT/US2024/030007

§ 371 Date: Nov. 13, 2025

Related U.S. Application Data
(60) Provisional application No. 63/467,506, filed on May 18, 2023.

(51) Int. Cl. H02M 1/00; B60L 15/00; B60L 53/24; H02M 1/084; H02M 1/088; H02M 7/797

(52) U.S. Cl. CPC H02M 1/007; B60L 15/007; B60L 53/24; H02M 1/084; H02M 1/088; H02M 7/797; B60L 2210/40

(57) ABSTRACT

Disclosed are implementations that include a power converter system and method including an N-phase power converter stage having to an alternating current (AC) side and a direct current (DC) side, with N≥1. The system and method further include an N-phase LC filter comprising one or more capacitors, wherein respective one or more neutral points of the one or more capacitors are electrically connected to a DC negative terminal of a DC source. A control system drives power switching elements of the N-phase power converter stage to convert received power and to output converted power. The control system drives the power switching elements using variable frequency soft switching at a frequency of at least 20 kHz. The power converter may have bidirectional operation to operate in a traction mode to drive a motor or a charging mode to charge a DC source.

### CROSS-REFERENCE TO RELATED APPLICATIONS

This application claims priority to U.S. Provisional Application No. 63/467,506, filed on May 18, 2023, titled “SYSTEMS AND METHODS FOR CONTROL OF NONISOLATED BIDIRECTIONAL POWER CONVERTERS,” which is hereby incorporated by reference in its entirety.

### STATEMENT REGARDING FEDERALLY SPONSORED RESEARCH

N/A

### BACKGROUND

Power converters of various types have been produced and used in many industries and contexts. Example power converters include alternating current (AC) to direct current (DC) rectifiers, DC to AC inverters, and DC to DC converters. AC to DC rectifiers, also referred to as AC/DC rectifiers, converter AC power to DC power. DC to AC inverters, also referred to as DC/AC inverters, convert DC power to AC power. Power converters can be used for various purposes, such as rectifying AC power from an AC grid power source to DC power for charging a battery, or inverting DC power from a battery to AC power to drive a motor or supply AC power to an AC grid. Further, power converters can be used in various contexts, such as in or connected to an electric vehicle, an engine generator, solar panels, and the like.

### SUMMARY

Power converters may be described in terms of power conversion efficiency, power density, and cost, among other characteristics. Generally, it is desirable to have power converters with higher power efficiency, higher power density, and lower cost. A highly efficient power converter is able to convert power (e.g., AC to DC, DC to AC, and/or DC to DC) without significant losses in energy. A low efficiency power converter experiences higher losses in energy during the power conversion. Such energy losses may manifest as heat generated by the power converter while converting power, for example. Power efficiency for a power converter, inductor, or other electronic component may be expressed as a percentage between 0 and 100% and determined based on the power input to the component and the power output from the component

$$Power Efficiency = \frac{Power Out}{Power In}$$

using the equation: A power converter with high power density has a high ratio of power output by the power converter compared to the physical space occupied by the power converter. The power density can be calculated using the equation:

$$Power Density = \frac{Power Out}{Volume of Power Converter} .$$

Energy costs, including monetary costs and environmental costs, continue to be an important factor across many industries that incorporate power converters. Accordingly, even slight increases (e.g., of tenths of a percent) in power efficiency for a power converter can be significant and highly desirable. Similarly, reductions in materials and size of power converters can be significant and highly desirable, allowing reductions in costs and physical space to accommodate power converters in systems that incorporate power converters.

In grid-connected power converter applications, such as electric vehicle (EV) chargers and photovoltaic (PV) power supplies, leakage current and DC bus utilization are factors that influence the performance. For the leakage current issue, a bulky line frequency transformer is typically installed to block the leakage path at the point of common coupling (PCC) which increases the cost, volume, and weight of the system. For the DC bus utilization, the DC bus voltage may be stepped up to be at least twice of the grid voltage amplitude to avoid saturation issue, which brings extra switching losses and challenges to the switch voltage tolerance capability.

Bidirectional power converters may be used to both charge a DC source using AC power and drive AC motors using DC power from the DC source. Such power converters, when included in an electric vehicle, may also be referred to as an integrated charger. An integrated charger may both be used as a primary charging interface for a battery of the electric vehicle, and also as the traction inverter to drive a motor of the electric vehicle. By using a dual-purpose power converter, rather than separate charger converter and traction inverter, material costs and size may be reduced. However, relative to dedicated power converters, dual-purpose power converters add complexities in designing an efficient and effective converter for both charging and traction modes. Further, the design factors extend beyond efficiency concerns because, without proper design, power converters can reduce motor lifetime due to leakage currents and/or common mode voltages causing current spikes in one or more of the motor bearings, motor shaft, motor windings, and gear train that can damage and reduce the lifetime of these components, respectively.

Some embodiments disclosed herein address these or other issues.

The foregoing and other aspects and advantages of the present disclosure will appear from the following description. In the description, reference is made to the accompanying drawings that form a part hereof, and in which there is shown by way of illustration one or more embodiment. These embodiments do not necessarily represent the full scope of the invention, however, and reference is therefore made to the claims and herein for interpreting the scope of the invention. Like reference numerals will be used to refer to like parts from Figure to Figure in the following description.

### BRIEF DESCRIPTION OF THE DRAWINGS

FIG. 1 is a schematic of a power converter system according to some aspects.

FIG. 2 is a partially exploded isometric view of a vehicle drive unit showing a plurality of auto converter modules (ACMs), according to some aspects.

FIG. 3 is a top view of the drive unit of FIG. 2.

FIG. 4 is an isometric view of an auto converter module, according to some aspects.

FIG. 5 illustrates a power converter system including a controller connected to multiple three-phase ACMs, according to some aspects.

FIG. 6 illustrates multiphase power converter system according to some embodiments.

FIG. 7 illustrates a hierarchical control system according to some embodiments.

FIGS. 8A-8C are flow charts illustrating control logic of a hierarchical control system, according to some embodiments.

FIG. 9 is a chart illustrating performance characteristics of cascaded and parallel power converter systems.

FIGS. 10 and 11 are charts illustrating efficiency of ACMs in parallel and cascaded ACMs respectively.

FIGS. 12 and 13 are charts illustrating combined efficiencies of motors and ACMs with the ACMs in parallel and cascaded configurations respectively.

### DETAILED DESCRIPTION

One or more embodiments are described and illustrated in the following description and accompanying drawings. These embodiments are not limited to the specific details provided herein and may be modified in various ways. Furthermore, other embodiments may exist that are not described herein. Also, functions performed by multiple components may be consolidated and performed by a single component. Similarly, the functions described herein as being performed by one component may be performed by multiple components in a distributed manner. Additionally, a component described as performing particular functionality may also perform additional functionality not described herein. For example, a device or structure that is “configured” in a certain way is configured in at least that way but may also be configured in ways that are not listed.

As used in the present application, “non-transitory computer-readable medium” comprises all computer-readable media but does not consist of a transitory, propagating signal. Accordingly, non-transitory computer-readable medium may include, for example, a hard disk, a CD-ROM, an optical storage device, a magnetic storage device, a ROM (Read Only Memory), a RAM (Random Access Memory), register memory, a processor cache, or any combination thereof.

In addition, the phraseology and terminology used herein is for the purpose of description and should not be regarded as limiting. For example, the use of “comprising,” “including,” “containing,” “having,” and variations thereof herein is meant to encompass the items listed thereafter and equivalents thereof as well as additional items. Additionally, the terms “connected” and “coupled” are used broadly and encompass both direct and indirect connecting and coupling and may refer to physical or electrical connections or couplings. Furthermore, the phase “and/or” used with two or more items is intended to cover the items individually and the items together. For example, “a and/or b” is intended to cover: a (and not b); b (and not a); and a and b.

Disclosed herein are systems and methods related to networked power converters (also referred to as voltage converters), where the networked power converters may be selectively enabled and driven by a control system dependent on various factors. In some examples, the networked power converters may be brought online or offline in a cascaded manner and, accordingly, may also be referred to as cascadable power converters. Further, the networked power converters may software-defined by selectively bringing the networked power converters online or offline, as well as by defining their operation (e.g., as a DC/AC traction inverter, an AC/DC rectifier and charger, a DC/AC inverter for powering an AC network, a DC/DC converter for powering a DC network, and/or a combined converter with DC/DC converter providing boost and/or buck function in combination with a DC/AC inverter or AC/DC rectifier). Accordingly, the networked power converters may also be referred to as software-defined power converters. The networked power converters enable adaptable power conversion that can provide increased power efficiency, increased power density, and/or reduced cost, among other advantages.

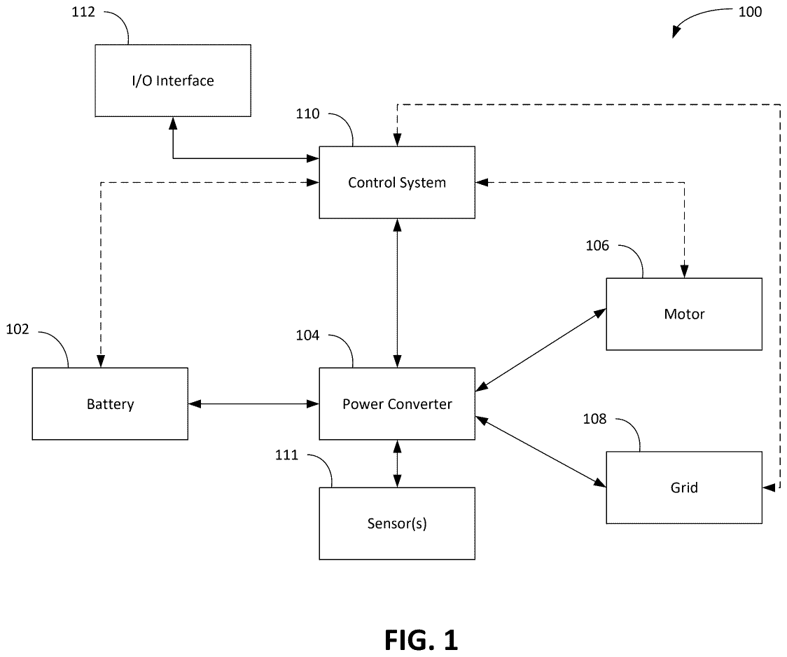

FIG. 1 is a schematic of a power converter system 100 according to some aspects. As detailed herein, the power converter system 100 may include networked power converters, also referred to as modular power converters or auto converter modules (ACMs). As shown in FIG. 1, the power converter system 100 can include a battery 102, which can produce a DC voltage to the system 100 or can be a DC load on the system (e.g., when the battery is charging). The battery 102 may include one or more battery cells. The one or more battery cells are energy storage mediums and can be of various types in different examples. For example, the one or more battery cells of the battery 102 may be lead acid, lithium-ion, lithium iron phosphate, hydrogen, or another chemistry. In some examples, the battery 102 can provide a voltage (e.g., a voltage across two terminals of the battery 102) of at least 12 V, at least about 400 V, at least about 500 V, at least about 600 V, at least about 700 V, at least about 800 V, or voltages greater than 800 V. In some aspects, the battery 102 can be a battery of an electric vehicle (EV) or a hybrid vehicle. In some aspects, the battery 102 can be a battery used in non-traction use cases, such as for example, a battery to power domestic or commercial loads (e.g., via providing power to the grid 108). Further, depending on the configuration or scenario of the system 100, the DC battery 102 can be a power source or a power load on the system.

In some examples, the DC battery 102 may be a direct power (DC) load, a DC source, or both a DC load and DC source (i.e., functioning as DC source in some instances and as a DC load in other instances). In some examples, a power converter system may include other DC load/sources alternatively or in addition to a DC battery (e.g., in addition to the DC battery 102). For example, a DC load/source for a power converter system may include a capacitor, an ultracapacitor, a DC power supply from rectified AC source (e.g., AC grid power converted to DC power by diode bridge rectifier), or the like.

As further shown in FIG. 1, the system 100 can also include a power converter 104 in electrical communication with the battery 102, or any such energy storage medium. The power converter 104 can invert a DC signal from the battery 102 into an AC signal at a given frequency. For example, the power converter 104 can output a signal at 120 V and 60 Hz. In some examples, a power converter system can include power electronics (e.g., insulated-gate bipolar transistor (IGBT), metal-oxide-semiconductor field-effect transistor (MOSFET), and gallium nitride (GaN) switches, etc.) for inverting a DC signal from the battery 102. The power electronics may also be referred to as power switching elements or switches. The power electronics can operate using pulse width modulation (PWM) to produce the AC signal from the DC signal. Further, the power converter 104 can be a single-phase inverter outputting a single phase of AC voltage, or a three-phase inverter, outputting three phases of AC voltage, each phase offset by each of the other phases by about 120 degrees. In some embodiments, the power converter system 100 can be referred to as an N-phase power inverter/converter and can produce any number of phases of AC voltage from a DC voltage. The power converter 104 can comprise one or more LC filters, as further described below.

In some examples, the power converter 104 can comprise a plurality of modular or networked power converters. The plurality of modular power converter can operate in parallel or in a cascaded mode to produce electric signals with desired power characteristics. In some examples, each modular power converter of the power converter 104 can be substantially similar or identical to the other modular power converters of the plurality of modular power converters of the power converter 104. In some examples, modular power converters can be non-uniform within a power converter, and different modular power converters can provide power characteristics suitable for different applications or loads, as described below. For example, in the context of an electric vehicle (EV), a first modular power converter can provide a first power output to drive an acceleration of an electric motor, while other modular power converters can provide AC power with different characteristics to maintain a speed of an electric motor. In some aspects, the power converter 104 can operate as a power converter system and can convert an AC signal to a DC voltage for powering DC loads (e.g., for charging the battery 102).

A power converter system 100 can further include AC loads (e.g., an AC motor and/or AC grid), which can be powered by an AC voltage output by an inverter from a DC source (e.g., the battery 102). For example, in FIG. 1, the power converter system 100 can include a motor 106, which is an example of an AC load. In some examples, the motor 106 can be a motor of an EV. In some embodiments, a power converter system 100 can be coupled to more than one motor. That is, the motor 106 may represent a plurality of motors, in some examples. The motor 106 can comprise a stator having one or more electromagnetic coils, and a rotor configured to rotate in response to an electromagnetic field generated at the one of more electromagnetic coils. In some examples, the motor is driven by three-phase AC voltages, and the stator of the motor includes at least one coil corresponding to each phase. In some embodiments, the motor can comprise an AC source, and a rotation of the rotor can induce an AC voltage in coils of the stator. For example, the motor 106 can operate as a generator (e.g., as when an EV is rolling downhill or braking) and an AC signal produced by the motor 106 can be converted to a DC voltage at the power converter/inverter 104 to charge the DC battery 102.

Further, in some examples, a power converter system can include more than one AC load or source. For example, as illustrated in FIG. 1, the power converter system 100 can include an AC power grid 108. In some examples, for example, the AC power grid 108 can receive an AC voltage from the power converter 104, thus allowing the grid to receive power from the DC battery 102. In some cases, the AC grid 108 is a power source (e.g., as when an EV is plugged into a power station to charge the battery 102). In some examples, the power converter 104 may be isolated from the AC power grid 108 and/or from the AC motor 106 (e.g., via respective transformers), and in other examples, the power converter 104 is non-isolated (e.g., connected to an AC load/source without a transformer). For example, in an isolated embodiment, a transformer may be electrically coupled between the power converter 104 and the motor 106, and/or a transformer may be electrically coupled between the power converter 104 and the AC grid 108.

As further shown in FIG. 1, the power conversion system 100 can further include a control system 110 to control operating parameters of the power converter system 100. In some examples, the control system 110 can include local controllers for individual components of the power converter system (e.g., the battery 102, the power converter 104, individual auto control modules of the power converter 104, the motor 106, and/or the AC power grid 108) and a master controller for the power converter system 100. In some cases, local controllers can be software controllers that are implemented using the same hardware as used for the master controller. In some cases, individual elements of a power control system 110 can include integrated controllers, and communication between local controllers and the master controller can be performed via a communications system (not shown), which could include a DC bus and employ an ethernet (ETH) protocol, a controller area network (CAN) protocol, serial peripheral interface (SPI) protocol, or any other communications protocol implemented over a wired or wireless connection.

In operation, generally, the control system 110 controls power switching elements of the power converter 104 with control signaling (e.g., pulse-width modulated (PWM) signals) to convert power from the battery 102 functioning as a source to the motor 106 or the AC power grid 108, or any other AC load that may be operably connected to the battery 102. Accordingly, when the battery 102 is functioning as a source for the power converter 104, the motor 106 (or AC grid 108) is functioning as a load for the power converter 104. Conversely, when the battery 102 is functioning as a load for the power converter 104, the motor 106 (or AC grid 108) is functioning as a source for the power converter 104.

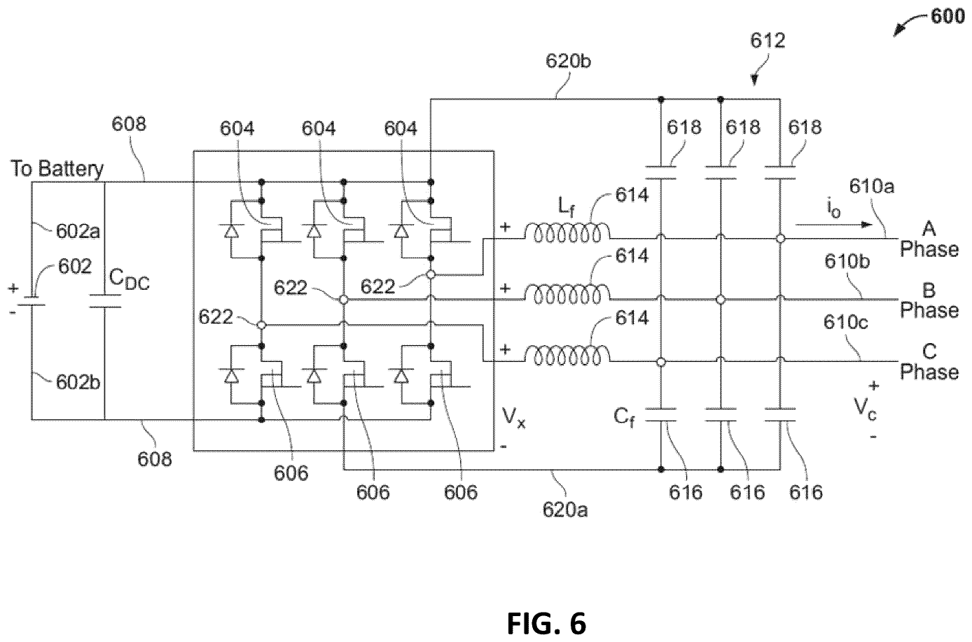

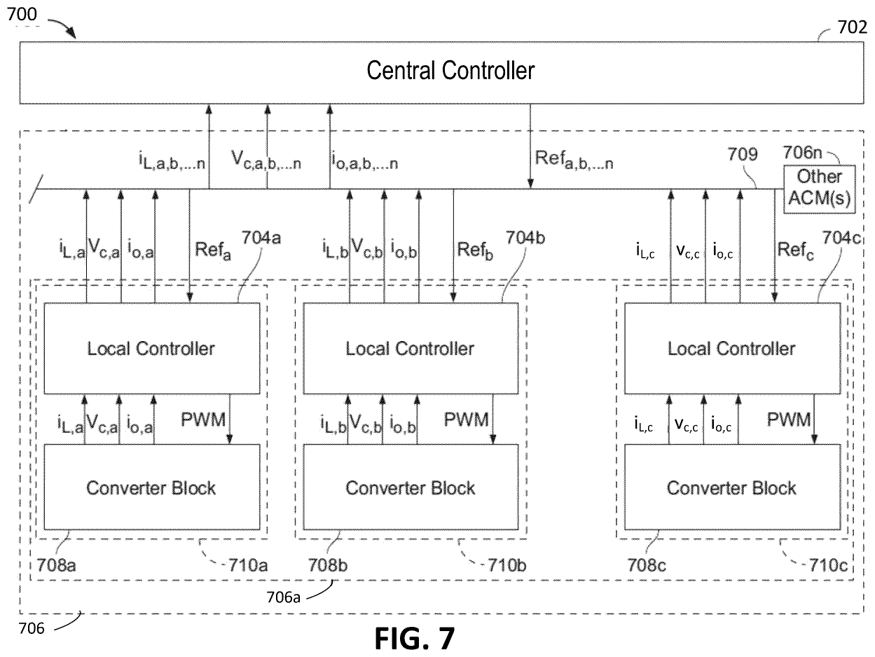

In some embodiments, the control system 110 can receive sensor data as inputs from one or more sensors 111 of the power converter system 100. For example, a controller of the control system 110 can receive temperature information for any or all of the battery 102, the power converter 104, the motor 106, and the AC grid 108 from respective temperature sensors of the sensors 111. The control system 110 can receive current and/or voltage measurements at any point along the modular converter from corresponding current and/or voltage sensors of the sensors 111 (see, e.g., FIGS. 6 and 7 for example current and voltage measurements). Further, the control system 110 can receive measurements of mechanical properties, including a rotational speed of the motor 106, a torque output at the motor 106, etc. from corresponding sensors of the sensors 111 configured to generate such measurements (e.g., rotary encoders, Hall sensors, torque sensors, etc.). In some embodiments, the control system 110 can receive inputs from an input-output (I/O) interface 112. In some examples, one or more of the sensor(s) 111 interfaces with the control system 110 via the I/O interface 112.

The input-output I/O interface 112 includes or is configured to receive input from one or more inputs (e.g., one or more buttons, switches, touch screen, keyboard, foot pedal, and the like), and/or includes or is configured to provide output to one or more outputs (e.g., LEDs, display screen, speakers, tactile generator, and the like). Other electronic devices and/or users may communicate with the system 100 and, in particular, the control system 110, via the I/O interface 112. For example, the control system 110 may receive commands (e.g., from a user or another device) for the power converter system 100 indicating a target torque, target speed, target power level, conversion type, or the like. The control system 110, in response, may drive the power converter 104 to achieve the target and/or conversion type indicated by the command. For example, in some cases, a user of the system 100 can indicate a desired throttle value by generating a throttle signal (e.g., at an acceleration pedal of an EV, at a console, a joystick, a keyboard, a touchpad, or any other input device of the I/O interface 112). The throttle value indicated by the throttle signal may, for example, correspond to a desired speed, acceleration, or torque for an electric vehicle that incorporates the system 100. The control system 110 can receive the throttle value, and can use the throttle value, either alone or in combination with sensed characteristics of the components of the system 100, to alter system characteristics to achieve a desired operating state, as further described below. In some cases, the control system 110 can implement proportional-integral derivative (PID) controllers, model predictive controllers, a cascaded or hierarchical control system including a global controller in combination with local controllers, (e.g., with the global controller implementing PID and each local controllers implementing PID or MPC control), to achieve set points in response to input values. In some examples, set points and operational modes may be set by the load or power converter system itself, rather than via explicit command. For example, when in a charging mode, the set point may be dictated by a voltage and/or current. In some examples (e.g., when the power converter is not integrated into an EV or operating in a traction mode), the set points or operational modes may be indicated by frequency (e.g., of a coupled AC network), transients in the system, power factor correction, or the like.

In some examples, the components of the system 100 of FIG. 1, aside from the grid 108, are integrated into a single device (e.g., an EV). In this example, grid connection points or terminals of the grid 108 may be integrated into the single device, while other portions of the grid 108 are separate from the single device. In other examples, the components of the system 100 of FIG. 1 are distributed between multiple devices. For example, the battery 102 may be integrated into an EV, while the control system 110 and the power converter 104 are integrated into an electric vehicle supply equipment (EVSE), such as, e.g., a charging station). In this example, the sensors 111 and the I/O interface 112 may be in the EV, in the EVSE, or distributed among both the EV and the EVSE; and, grid connection points or terminals of the grid 108 may be integrated into the EVSE, while other portions of the grid 108 may be separate.

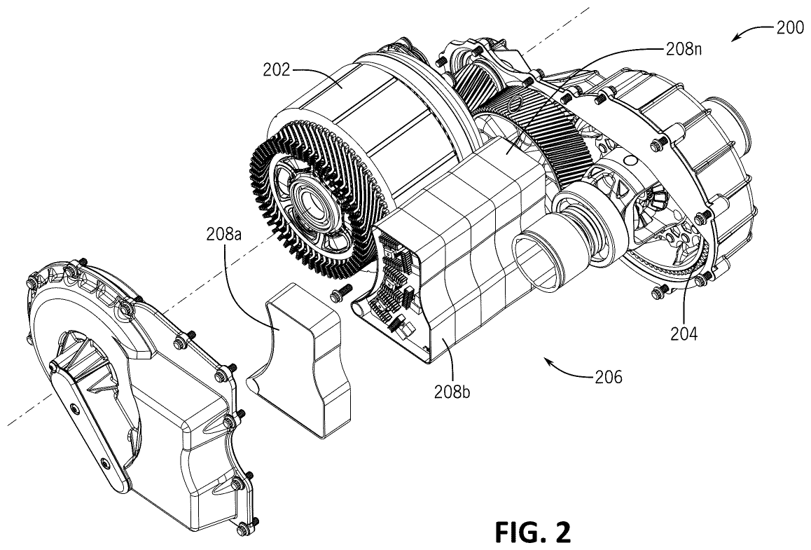

FIG. 2 is a partially exploded isometric view of a vehicle drive unit 200. The drive unit 200 includes a motor 202 (e.g., an example of motor 106 illustrated and described with respect to FIG. 1). The motor 202 can be a motor of an EV and can be mechanically coupled to a transmission assembly 204 including a plurality of gears configured to rotate about respective axes that are parallel to a rotational axis 203 for a rotor of the motor 202. As used herein, an EV may refer to, for example, a passenger car, a commercial vehicle (e.g., bus, semitruck, etc.), an industrial vehicle (e.g., shovel, front loader, fork truck, etc.), an aerospace vehicle (e.g., an airplane, helicopter, etc.), or a marine craft (e.g., boat, submarine, etc.). In the context of an EV, the motor 202 (or 106) may be referred to as a propulsion motor configured to propel the EV. In the context of a land-based EV (e.g., passenger car, commercial vehicle, industrial vehicle), the motor 202 (or 106) may be referred to more specifically as a traction motor configured to propel the EV over land.

The motor 202 may be, for example, a permanent magnet rotor synchronous machine, a wound field synchronous machine (WFSM), or another motor. The motor 202 may include a stator and rotor. The stator may include a plurality of stator windings that may be driven with current to generate a changing magnetic field to cause the rotor to rotate. The rotor may include permanent magnets, wound field, or a combination (hybrid) of permanent magnets and wound fields. The rotor may be coupled to a motor shaft such that, when the rotor is rotatably driven, the motor shaft is rotatably driven (i.e., rotated). The motor windings of the stator and/or rotor may have insulation, which, as noted above, can be damaged if exposed to excessive currents resulting from high rates of change of voltage (dV/dt). The motor shaft may be supported by one or more motor bearings to enable the support and rotation of the shaft. For example, the motor shaft may include a first motor bearing at a driven end of the shaft (an end of the shaft coupled to the rotor) and a second motor bearing at a distal end of the shaft. In some examples, other motor bearing arrangements are used. The motor shaft may be further coupled the transmission 204 (e.g., a gear train) that drives an end load. For example, in the case of an electric vehicle, the transmission may ultimately be coupled to one or more wheels to cause the vehicle to be propelled. In other examples, the motor is part of an industrial equipment and causes rotation of another load (e.g., cutting instruments, grinders, conveyer motors, etc.).

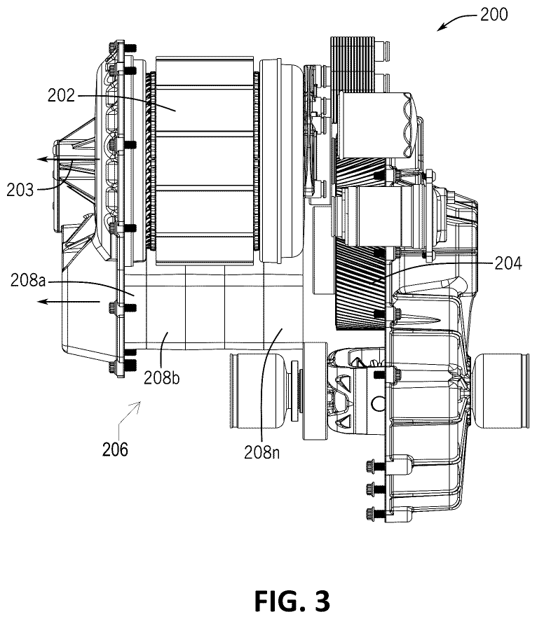

As further shown in FIGS. 2 and 3, the vehicle drive unit 200 includes a power conversion assembly 206 (e.g., an example of power converter 104 shown in FIG. 1) including a plurality of auto converter modules (ACMs) 208. As shown, the power conversion assembly 206 includes a first ACM 208a, a second ACM 208b, up to an nth ACM 208n. In the illustrated embodiment the power conversion assembly 206 includes seven ACMs 208. In other examples, a power conversion assembly can include fewer than seven ACMs, or more than seven ACMs. In some cases, a number of ACMs provided for a motor, or for non-traction loads can correspond to system characteristics. For example, if more torque or power is needed for a motor, more ACMs can be provided. Correspondingly, if less power is required, fewer ACMs can be provided, which can reduce a total volume, weight, and cost of a vehicle drive unit, for example.

It can be advantageous to reduce a part count in production of ACMs for a vehicle drive unit, and therefore, ACMs can include identical geometries. For example, as further shown in FIGS. 2 and 3, each of the ACMs 208 are relatively identically shaped, and include concave indented portions to accommodate corresponding convex portions of the motor 202 and the transmission assembly 204. As further shown, the ACMs 208 can be stacked in a direction parallel to the rotational axis 203 of the rotor, and additional ACMs 208 can be added to meet additional power demands or removed to meet reduced power demands. Further, with the same module, multiple power converter systems can be defined for a platform (e.g., an EV platform having several EV models with different characteristics) without requiring a redesign of a front drive unit, primary drive unit for different vehicle classes. Accordingly, EV development cost may be reduced, speed to deploy new drive units and EVs may be reduced, prices for modules and components thereof may be reduced through increased use thereof, and/or manufacturing costs and stock keeping unit (SKU) counts can be reduced.

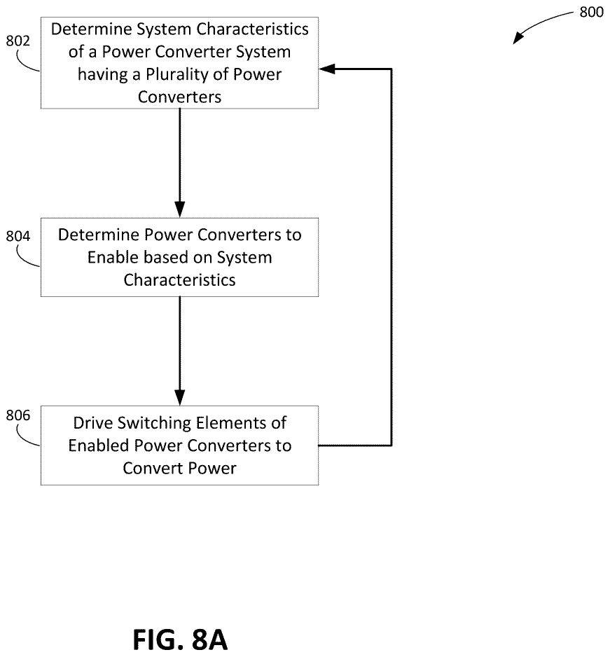

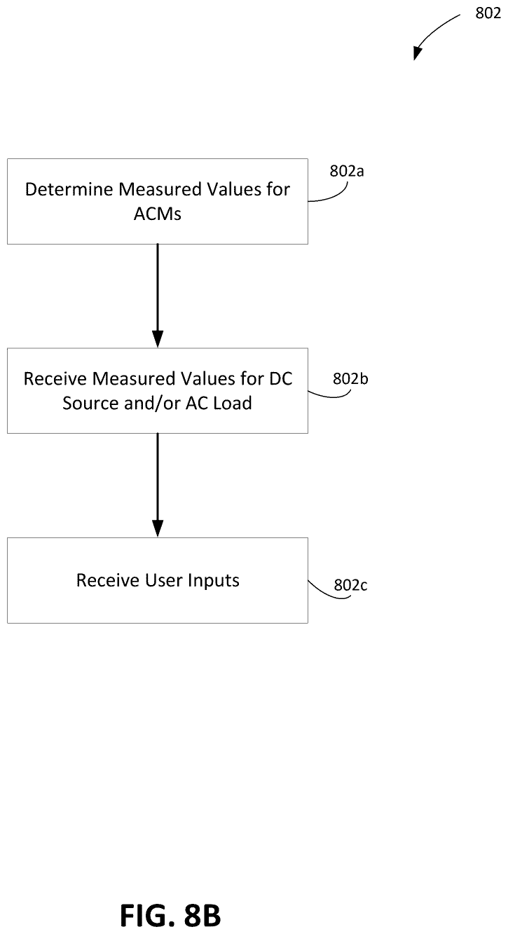

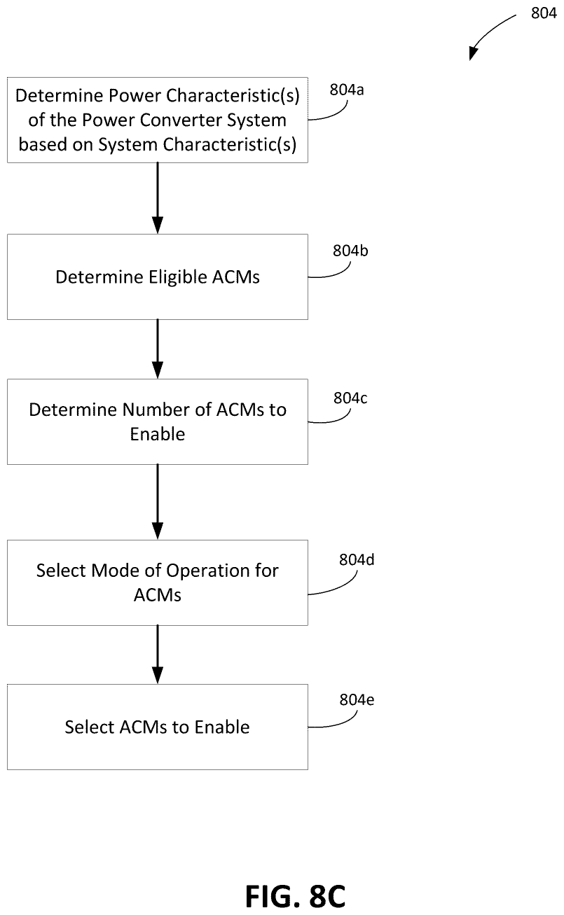

Additionally, the modular nature of the power conversion assembly 206 and the ACMs 208 may be controlled to provide a self-healing architecture. For example, as described in further detail below with respect to FIG. 8, ACMs may be selectively enabled and disabled. Accordingly, in the event of a faulting or failed ACM of the ACMs 208, the ACMs 208 that remain operational may continue operation while the failed ACM is disabled. Thus, for example, if each ACM 208 of a five-ACM power conversion assembly is capable of providing (or receiving) a 50 kW, three-phase AC signal, the assembly may be referred to as a 250 KW system. If one ACM 208 fails, the system may still have four operational ACMs capable of providing 200 kW, three-phase AC signal. Thus, the power conversion assembly 206 and the ACMs 208 may experience a failure, but continue operating at a reduced capacity commensurate with the remaining operational ACMs, rather than have a system-wide failure. Further, the power conversion assembly 206, even at reduced capacity, still operates at high efficiencies at partial load because, for example, of soft-switching and/or the sine wave output, which can reduce system costs elsewhere (e.g., with respect to the battery) that may otherwise be incurred to plan for such potential operation at reduced capacity.

As described with respect to FIG. 1, each of the ACMs 208 can operate to invert a DC signal into an AC signal. Additionally, each of the ACMs 208 can operate to convert an AC signal to a DC signal, as further described below. ACMs of a vehicle drive unit can convert a DC input into a three phase AC voltage output. In some cases, ACMs can invert a DC signal into a single-phase AC signal, or into an AC signal with more than 3 phases. In some cases, one or more ACMs 208 may be configured to provide DC/DC power conversion (e.g., to receive DC power from a battery and provide a boosted or bucked DC voltage to other ACMs 208 to invert and output as AC power, or to receive DC power rectified by other ACMs 208 and to boost or buck the DC power for receipt by a battery).

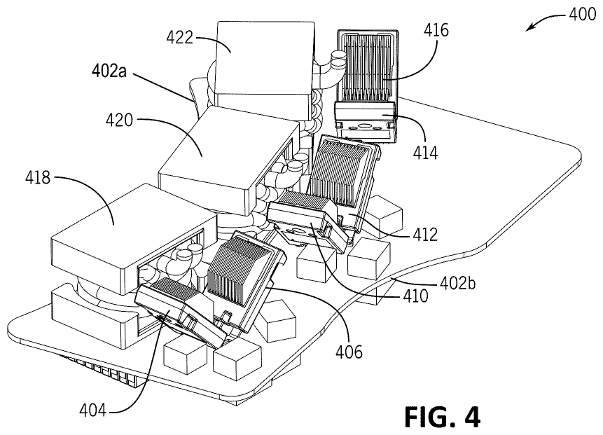

FIG. 4 is an isometric view of an ACM circuit board 400, according to some aspects. The ACM circuit board 400 can include electronic components to output multiple phases of AC power signal from a single DC input signal, and/or to provide a DC output signal from one or multiple phases of an AC input power signal. The ACM circuit board 400 may be housed in an ACM 208, as illustrated in FIG. 2 and FIG. 3. In some examples, an ACM 208 houses two ACM circuit boards 400. As illustrated, the ACM circuit board 400 may have a curved perimeter that mirrors the perimeter of and fits within the ACM 208. For example, the ACM circuit board 400 may have a first cutaway 402a to follow a motor 202 shape and a second cutaway 402b to follow a driven shaft of the transmission assembly 204. In other examples, the ACM circuit board 400 has a different shape than illustrated.

As shown, the ACM circuit board 400 can include a first pair of field effect transistors (FETs) 402, 404, a second pair of FETs 406, 408, and a third pair of FETs 410, 412. In some examples, FETs provided for ACMs (e.g., pairs of FETs housed on an ACM circuit board) can be a junction FET (JFET), a metal oxide semiconductor FET (MOSFET), a gallium nitride (GaN) FET, a silicon carbide (SiC) FET, or any other type of FET. In some examples, FETs of an ACM perform switching to implement pulse width modulation (PWM) to convert a DC signal into an AC signal with a desired amplitude and frequency. For example, the FETs 404, 406 can implement PWM in response to a pulse-width modulated input control current to produce an output AC signal at a first phase, with a defined amplitude and frequency. For example, in some cases, the output signal of the first pair of FETs 404, 406 can be an AC signal with a voltage of root mean squared (RMS) 120 V (i.e., with amplitude (peak-to-peak) of 340 V) and a frequency of 60 hz. The output signal of the second pair of FETs 406, 408 can be similar to the output signal of the first pair of FETs 404, 406 (e.g., an output voltage of RMS 120 V and a frequency of 60 hz), but the signal can be shifted 120 degrees from the phase of the signal produced by the first pair of FETs 404, 406. Similarly, the output AC signal of the third pair of FETs 414, 416 can be shifted 120 degrees from the output signal of the second pair of FETs 410, 412. In some examples, other voltage levels and/or frequencies are of AC signals are generated by the FETs 404-414 and the ACM circuit board 400. In some examples, a power conversion module (e.g., an ACM) can use switching components other than FETs to invert a DC signal to AC, including, for example, insulated gate bipolar transistors (IGBTs) or other transistor elements.

Further, each phase of AC current produced by an ACM can be filtered to produce the desired signal characteristics and filter out unwanted frequencies or amplitudes of AC current. In some examples, an AC signal from FETs of an ACM can be filtered by an LC filter before the signal is provided to power a downstream AC load (e.g., a motor). As shown in FIG. 4, the ACM circuit board 400 can include inductor coil 418, 420, 422 to provide inductance for the LC filters. As shown, a first inductor coil 418 can be electrically downstream of the first pair of FETs 404, 406 to produce the first phase of AC voltage. Similarly, a second inductor coil 420 can provide inductance for an LC filter along the second phase of AC voltage, and the third inductor coil 422 can provide inductance along the third phase of AC voltage.

In some examples, the ACM circuit board 400 may also be bidirectional in that the ACM circuit board 400 may convert received AC voltage (e.g., from a motor 106 or 202 or grid 108) to DC voltage (e.g., to charge a battery 102). For example, the FETs 404-414 of the ACM circuit board 400 implement PWM in response to a pulse-width modulated input control current to produce an output DC voltage at a defined amplitude based on AC voltage received at the FETs pairs 404-414 (e.g., each FET pair of FETs 404-414 receiving a phase of a three phase AC voltage).

In some examples, the ACM circuit board 400 further includes a portion of a control system that controls the components (e.g., the FETs) of the ACM circuit board 400. For example, the ACM circuit board 400 may include the control system 110 or a portion thereof. For example, the ACM circuit board 400 may include a local controller for controlling the particular ACM circuit board 400 (see, e.g., discussion of local controllers 704 with respect to FIG. 7) and/or a central controller (see, e.g., discussion of central controller 702 of FIG. 7).

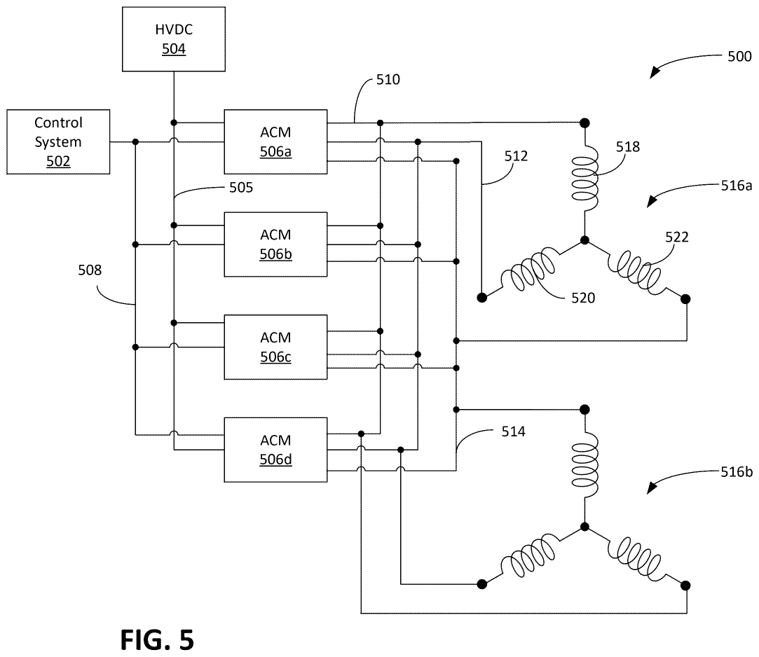

FIG. 5 illustrates a power converter system 500 including a control system 502, a high-voltage DC (HVDC) power supply 504, a plurality of ACMs 506a-d, and motors 516a-b. With brief reference back to FIG. 1, the power converter system 500 may be an example of the power converter system 100, where the DC power supply 504 may be a battery similar or identical to the battery 102 described with respect to FIG. 1, the ACMs 506a-d may collectively be an example of the power converter 104, the control system 502 may be an example of the control system 110, and the motors 516a-b (individually or collectively) may be an example of the motor 106. Additionally, elements of FIG. 1 not illustrated in FIG. 5 may nonetheless be present in the power converter system 500.

The ACMs 506a-d may be generically referred to as an ACM 506 (individually) or the ACMs 506 (collectively). The ACMs 506 may also be referred to as networked, cascadable, and/or software-defined power converters. The motors 516a-b may be generically referred to as a motor 516 (individually) or the motors 516 (collectively). The HVDC power supply 504 can provide a DC voltage input via DC bus 505 to each of the ACMs 506, to be inverted into a three-phase AC signal, as illustrated. The control system 502 can be in communication with each of the ACMs 506 to provide input signals (e.g., a control signal) to each ACM 506 to control switching elements of the ACM (e.g., FETs of the ACM). A control signal from the control system 502 can further control a state of a particular ACM (e.g., enabled or disabled), an operating mode of the plurality of ACMs (e.g., parallel or cascaded), and/or characteristics of an output signal to be produced by one or more ACMs (e.g., the controller-provided control signal(s) can include or ultimately indicate PWM control signal(s) for FETs of the ACMs 506 to produce output signals with desired characteristics). As shown, the control system 502 can be connected to the ACMs 506 via a communications interface 508 (also referred to as a communication network). In the illustrated example, the communications interface 508 is a DC controller area network (CAN) bus. In some examples, the communications interface can include a wired ethernet (ETH) connection or a serial peripheral interface (SPI) connection. In some examples, a communications interface for a power converter system can be wireless (e.g., a controller can communicate with ACMs 506 via a Bluetooth, Wi-Fi connection, a cellular connection, or the like). The ACMs 506 may be considered networked power converters at least because they are configured to communicate with one another and/or the control system 502 via the communications interface 508.

In some examples, the control system 502 is a hierarchical control system formed by a central controller in combination with one or more local controllers associated with each ACM 506. For example, each ACM 506 may include, for each phase, a converter block having a converter circuit with power switching elements and an LC filter (see, e.g., converter 600 of FIG. 6 and/or converter blocks 708a-c of FIG. 7) and a local controller (see, e.g., local controllers 704a-c of FIG. 7), where the local controller is both part of the control system 502 and the ACM 506. As further illustrated in FIG. 5, each ACM 506 can output three phases of AC voltage. For example, a first phase of AC voltage from each of the ACMs 506a, 506b, 506c, 506d can be provided to a first phase output line 510, a second phase of AC voltage from each of the ACMs 506a, 506b, 506c, 506d can be proved to a second phase output line 512, and a third phase of AC voltage from each of the ACMs 506a, 506b, 506c, 506d can be provided to a third phase AC output line 514.

The ACMs 506a, 506b, 506c, 506d can each be uniform, providing similar or identical power outputs as each of the other ACMs 506a, 506b, 506c, 506d. For example, when two or more ACMs are uniform or substantially similar, the ACMs may have similar topologies comprised of components that are similarly sized and rated (e.g., within a tolerance of 0.5%, 1%, 2%, or 5%). For example, each corresponding FET, capacitor, inductor, etc. between uniform or substantially similar ACMs may be the same model type with similar power ratings (e.g., within a tolerance of 0.5%, 1%, 2%, or 5%), similar layout, similar size, similar construction materials, etc. Accordingly, uniform ACMs are expected to provide similar outputs for similar inputs, to wear at a similar rate, and generally behave similarly.

In contrast, in some examples, one or more of the ACMs 506 can be specialized to provide specific power characteristics adapted to a particular load. For example, ACM 506a can have a higher power rating than the other ACMs 506b-e and, accordingly, adapted to provide greater power to enable greater torque output by one or more of the motors 516a, 516b (e.g., by providing a higher current or greater ratio of voltage to frequency). For example, when an ACM is specialized, it may have a unique topology (compared to another ACM) and/or one or more components that are sized or rated to handle increased (or decreased) loads. Accordingly, an ACM 506 may be a high-power ACM 506 because it has one or more FETs, capacitors, inductors, or other circuit components that are sized or rated for higher output power than those components of another ACM. In another example, an ACM 506 may be a low-power ACM 506 because it has one or more FETs, capacitors, inductors, or other circuit components that are sized or rated for lower output power than those components of another ACM.

The controls system 502 can enable the ACM 506a when higher torque is required for the motors 516a, 516b (e.g., for accelerating to increase speed) and disable the ACM 506a when higher torque is no longer required at one or more of motors 516a, 516b (e.g., for maintaining speed). In some examples, one or more of ACMs 506 can be optimized for charging the HVDC power supply 504, and the controller can enable those ACMs 506 when AC sources (e.g., motors 516a,b or an AC grid) are provided and the HVDC power supply 504 functions as a load in the system 500. In some examples, ACMs 506 can be provided for non-traction loads and power characteristics of individual ACMs can be adapted for specific workloads in a given application. For example, the ACMs 506 may be part of a system (integrated with or separate from an EV) that provides power to an AC grid (e.g., for commercial or residential applications), or part of electric vehicle supply equipment (EVSE) in the form of a standalone EV battery charging station (e.g., where the ACMs 506a-d are connected to an AC grid in place of the motors 516a,b and charge the HVDC power supply 504 that is part of an EV separate from the EV battery charging station). Further, although the power converter system 500 is illustrated with four ACMs 506a-d, in some examples, the power converter systems 500 includes fewer or more ACMs 506. For example, as noted with the ACMs 208 in FIGS. 2-3, additional ACMs 506 may be included to increase the power available from the power converter system 500 (e.g., to drive the motors 516), to provide an additional dedicated charging ACM 506 (to charge a battery of the power supply 504), or the like. Similarly, fewer ACMs 506 may be included in the power converter system 500 to reduce the volume, weight, and cost of the power converter system 500.

As illustrated in FIG. 5, the motors 516a, 516b can receive AC signals (e.g., the AC voltage and AC current output at output lines 510, 512, and 514). In the illustrated example, the power converter system 500 includes two motors 516. In other examples, a power converter system can include only one motor, or more than two motors. For example, in some cases, an EV can include individual motors for each wheel of the vehicle, and the power converter system can provide power to drive each of the wheels. In some cases, an EV can include a single motor to drive a front or rear axle.

As shown, each of the motors 516a, 516b can include multiple coils to generate an electromagnetic field to drive rotation of a rotor of the motor. For example, coils 518, 520, and 522 are illustrated for motor 516a. Each coil can correspond to a given phase of AC current. For example, as shown, coil 518 is connected to output line 510 to receive a first phase of AC voltage, coil 520 is connected to output line 512 to receive a second phase of AC voltage, and coil 522 is connected to output line 514 to receive a third phase of AC voltage. In some examples, the motor 516a has more than three stator coils. For example, in some examples, each coil 518, 520, and 522 in the diagram represent multiple respective stator coils on the motor 516a. In some examples, the motor(s) 516a and/or 516b is a wound field synchronous motor including one or more rotor windings (not shown in the diagram) that may also be driven with current provided by the power supply 504 to generate a magnetic field for interaction with the stator coils of the motor(s) 516a and/or 516b (e.g., coils 518, 520, 522).

FIG. 6 is a circuit diagram of a multiphase converter 600 according to some examples. The multiphase converter 600 can be partially or fully included in an ACM (e.g., any or all of ACMs 208 illustrated in FIGS. 2 and 3, ACM circuit board 400 illustrated in FIG. 4, or ACMs 506). As shown, the multiphase converter 600 can be coupled to a battery 602 (e.g., a DC power source), illustrated as a battery 602, on a DC side and can output multi-phase AC signals on an AC side. The multiphase converter 600 may serve as the power converter 104 of the system 100 in FIG. 1, or as converter circuitry or blocks of an ACM thereof. For example, the multiphase converter 600 may be paired with a local controller for each phase of the multiphase converter 600 and, together the converter 600 and three local controllers form an ACM (e.g., an ACM 208 or 506). With reference to FIGS. 1 and 5, the battery 602 is an example of the battery 102 (e.g., the DC load/source) and the power supply 504, respectively. Returning to FIG. 6, in operation, the multi-phase converter 600 may function as a DC/AC inverter or an AC/DC rectifier, depending on the sources and switching of the power switching elements at a given moment.

The multiphase converter 600, also referred to as a power converter stage, includes three instances of a power converter (or three converter blocks), one for each phase of a multi-phase AC signal output by the multiphase converter (e.g., the A phase, B phase, and C phase outputs as shown in FIG. 6). Each instance of the power converter (or converter block) includes an upper and a lower switch 604 and 606. The upper and lower switch 604, 606 can correspond to FETs of a pair of FETs, as illustrated in FIG. 4. For example, the FET 404 can correspond to one of the upper switches 604, and the other FET 406 of the first pair of FETs can correspond to the lower switch 606 immediately opposite the upper switch 604. Although not illustrated, each switch 604 and 606 may include a respective drain-source capacitor coupled thereacross. The multiphase converter 600 is further coupled, via DC terminals 608, to the battery 602, and via interface terminals 610a, 610b, 610c to one or more AC load or source (e.g., the motor 106 and/or AC grid 108 shown in FIG. 1, the motor 202 of FIGS. 2-3, or the motor 516a and/or 516b of FIG. 5). More particularly, the interface terminals 610a can be an output of a first phase of AC voltage, the interface terminal 610b can be an output of a second phase of AC voltage, and the interface terminal 610c can be an output of a third phase of AC voltage (e.g., interface terminals 610a, 610b, 610c can correspond to output lines 510, 512, 514 respectively as shown in FIG. 5). The multiphase converter system 600 includes three LC filters 612. Each LC filter 612 includes a switch-side inductor 614 (also labeled L_{fs,a}, L_{fs,b}, or L_{fs,c}), a lower capacitor 616 (also labeled Cf,a, C_{f,b}, and Cf,_{c}), an upper capacitor 618 (also labeled C_{f,a}, C_{f,b}, or C_{f,c}). A neutral point 620a of the lower capacitors 616 is coupled to the negative DC terminal 602b, such that the neutral point 620 and the negative DC terminal 224 are a common node. Similarly, a neutral point 620b of the upper capacitors 618 is coupled to the positive DC terminal 602a. The switch-side inductor 614 is coupled between the midpoint node 622 and the filter node 624. Although the multiphase converter system 600 includes the upper capacitor 618 for each phase, in some examples, the upper capacitors 618 are not included.

As further illustrated in FIG. 6, in some examples of the power converter systems provided herein, the LC filter 612 includes an LC filter for each phase, where a common point of each lower capacitor is connected to a DC bus negative terminal and/or a common point of each upper capacitor is connected to a DC bus positive terminal of the DC terminals 608. This connection creates a bypassing path for zero-sequence voltage control. By leveraging the topological modification and zero-sequence voltage control, the common mode voltage of the converter 600 can be stabilized to reduce leakage current. Based on the topology and control, and sinus output of the converter 600, the power converter systems provided herein may include no or limited additional filtering beyond the per-phase LC filters (e.g., the converter 600 may include no common mode choke) and may have limited shielding on wires (as the operation of the converter 600 does not result in large bearing currents or other currents that can cause shielding breakdown).

In some embodiments, a power converter system (e.g., similar to system 100 illustrated in FIG. 1) has an N-phase power converter and a hierarchical control system. The N-phase power converter may be, for example, the power converter 104 or 600. In some examples, the N-phase power converter may be isolated from an AC load/source (e.g., via a transformer), and in other examples, the N-phase power converter is non-isolated (e.g., connected to an AC load/source without a transformer). For example, in an isolated embodiment, the power converter 600 may further include a transformer coupling the interface terminals 610a-c to an AC load/source. A hierarchical control system includes a central controller and at least one local controller, as discussed in further detail below.

FIG. 7 illustrates a hierarchical control system 700, and the description of control system 700 may apply either fully or partially to the control system 110 illustrated in FIG. 1 and/or to the control system 502 illustrated in FIG. 5. As noted above, the control system 700 may be a hierarchical control system including the central controller 702 cascaded with one or more local controllers 704, individually labeled 704a, 704b, and 704c. When the control system 700 is referred to as the hierarchical control system 700 herein, the control system 700 should be understood to include at least one of the local controllers 704 in addition to the central controller 702. The hierarchical control system 700 may provide, for example, resonance damping, improved dynamic performance, and/or leakage current attenuation capabilities. Additionally, the hierarchical control system 700 can improve the modularity of the components (e.g., easing the addition and removal of local controllers and corresponding converter blocks as ACMs). FIG. 7 further illustrates converter blocks 708, individually labeled as 708a, 708b, and 708c. Although illustrated in FIG. 7 for ease of understanding, the converter blocks 708 represent the power converter components controlled by the hierarchical control system 700 similar to, for example, the power converter 104 of FIG. 1 and the converter 600 of FIG. 6; thus, the converter blocks 708 may be considered separate from the hierarchical control system 700.

In some embodiments of the hierarchical control system 700, the central controller 702 provides an outer loop of control, while each of the local controllers 704 provides a distinct inner loop of control. For example, the central controller 702 may implement a PI controller, PID controller, or other regulating controller, that regulates the control for a power converter 706, or for individual ACMs 706a, 706n of the power converter 706 in a rotating reference frame (e.g., the dq0 reference frame). The individual ACMs 706a, 706n may be similar to the ACMs 208 illustrated in FIGS. 2 and 3, and ACMs 506 illustrated in FIG. 5. While the discussion below references ACM 706a, the control system 700 can control one or more other ACMs of the power converter 706 (e.g., ACM(s) 706n) in a similar or identical manner as described for ACM 706a. For example, each ACM 706a, 706n may be coupled to a bus 709 to communicate with the central controller 702, to provide information to the central controller 702 (e.g., i_{L}, V_{c}, i₀) and to receive information from the central controller 702 (e.g., control reference targets for each phase (e.g., Ref_{abc})). Additionally, the control system 700 can implement processes and workflows across multiple ACMs of a power converter, including the process 800 described in FIG. 8A. As part of the outer loop of control, the central controller 702 generates control reference targets (e.g., targets Refₐ, Ref_{b}, Ref_{c}) based on the regulation in the rotating reference frame. The control reference targets may be generated in the stationary (abc) reference frame. Additionally, the central controller 702 may provide the control reference targets to the local controllers 704. The local controllers 704 may be configured to control one or more of the N phases of the ACMs 706a, 706n of the power converter 706, where the control of the N phases of the power converter 706 is divided up among the local controllers 704. Thus, each phase of each ACM 706a, 706n of the power converter 706 may be associated with and controlled by a particular local controller 704.

Each respective local controller 704 implements the inner loop control via model predictive control (MPC), PI control, PID control, or another regulating technique, based on the control reference targets (e.g., target voltages to achieve operational parameters for the system, which can include a target velocity, acceleration, maximum heat flux, current, torque, etc.) received from the central controller 702. For example, each local controller 704 may also receive a voltage measurement or estimate for the voltage across the lower capacitor 616 (v_{c}) (illustrated in FIG. 6) associated with the same phase or converter block 708 as the local controller. Based on the measured or estimated capacitor voltage (v_{c}) and the control reference target (e.g., v_{c}*), each local controller 704 may control its associated converter block 708 to adjust or control the switching of the power switching elements to achieve (or tend towards) a capacitor voltage (v_{c}) that is equal to the reference control target. The inner loop control provided by the respective local controllers 704 includes the generation of control signaling provided to the power switching elements of the ACM 706a (or, in FIG. 6, of the converter 600). For example, with reference to FIG. 6, the local controller 704a provides control signaling to the power switching elements 604, 606 of a first phase of the ACM 706a (of converter block 708a), the local controller 704b provides control signaling to the power switching elements 604, 606 of a second phase of the ACM 706a (of converter block 708b), and the local controller 704c provides control signaling to the power switching elements 604, 606 of a third phase of the ACM 706a (of converter block 708c). The control signaling provided by each local controller 704 may be a PWM signal of a particular duty cycle and frequency. The duty cycle may be determined using a regulator scheme (e.g., PI, PID, or MPC algorithm) based on the control reference target received from the central controller and estimated or measured values for the phase associated with the particular local controller. The frequency may be selected using a variable frequency soft switching algorithm that identifies the frequency that will enable a soft switch of the power switching elements. By varying the switching frequency to achieve soft-switching, as opposed to hard switching, high turn-on losses of the upper switch are substituted with low turn-off losses of the lower switch of a converter block. More particularly, in some examples, to realize soft switching, each local controller 704 reshapes the phase leg inductor current ripple such that the vertex and nadir points are positive and negative. The vertex and nadir point ripple value should be large enough to guarantee a full soft switching. For example, each local controller 704 may receive or determine the inductor current (I_{L}), dc rail voltage (v_{dc}), and inductance of the inductor (L_{f}), and determined duty cycle, and determine from these inputs a switching frequency (f_{sw}) to achieve soft switching for the converter lbock that the local controller drives. The desired switching frequency (f_{sw}) may be derived according to a threshold current, Iₜₕ, of soft switching operation criteria. The phase leg side inductor current ripple, Δi_{L}, can be demonstrated as

$$Δ {i}_{L} = \frac{d ( 1 - d ) {v}_{dc}}{{f}_{s} {L}_{f}}$$

and the soft switching operation criteria require the vertex and nadir points of the phase leg side inductor current values to be larger than Iₜₕ and smaller than −Iₜₕ. Thus, the derivation of the time-varying switching frequency, f_{sw}, can be demonstrated as

$${f}_{s w} = \frac{( 1 - d ) {dv}_{dc}}{2 ( {i}_{L , ave} + {I}_{t h} ) {L}_{f}} , {i}_{L , ave} \geq 0$$

$${f}_{s w} = \frac{( 1 - d ) {dv}_{dc}}{2 ( {I}_{t h} - {i}_{L , ave} ) {L}_{f}} , {i}_{L , ave} \leq 0$$

in which i_{L,ave} represents the mean value of phase leg side inductor current.

The central controller 702 and the local controllers 704 may communicate with each other in real time (e.g., each control cycle) both monitoring information (e.g., sensor data) and control information. For example, each local controller 704 may determine and transmit, in real time to the central controller 702, electrical operational characteristics particular to the phase or phases of the ACM 706a with which the local controller 704 is associated. For example, with reference to FIG. 4, these electrical operational characteristics may include one or more of V_{c,abc}, i_{o,abc}, and i_{L,abc} (e.g., V_{c,a}, i_{o,a}, and i_{L,a} from local controller 704a; V_{c,b}, i_{o,b}, and i_{L,b} from local controller 704b; and V_{c,c}, i_{o,c}, and i_{L,c} from local controller 704c). In some embodiments, the local controllers 704 provide other electrical operational characteristics. Additionally, the central controller 702 may determine and transmit, in real time to the respective local controllers 704, the control reference targets (Ref_{a,b, . . . n}). In some examples, control reference targets are voltage reference targets (e.g., V_{c,abc}*), as discussed above. In some examples, the control reference targets are current reference targets (e.g., i_{L,abc}*). In such examples, the local controllers 704 may control the power switching elements of their respective phases in accordance with the current reference targets.

As further illustrated in FIG. 7, the hierarchical control system 700 illustrates an example of the communications for at least some examples of the converter system 100 illustrated in FIG. 1 and the converter system 500 illustrated in FIG. 5. For example, the hierarchical control system 700 is an example of a hierarchical control system that enables the communications described above with respect to hierarchical control systems.

The hierarchical control system 700 includes the central controller 702 and local systems 710a-c. Each local system 710a-c includes a respective local controller 704a-c and a respective local converter or converter block 708a-c (instances of the converter block 708 described with respect to the power converter 600 of FIG. 6). With reference also to FIG. 6, each converter block 708 may include a pair of power switching elements 604, 606 and an LC filter 612. The converter blocks 708, although illustrated in FIG. 7, may be considered separate from the control system and, rather, part of the power converter (e.g., as illustrated in FIG. 1 with separate control system 110 and power converter 104). Further, each ACM (e.g., ACM 208, 506, 706a, 706n) may include a portion the power converter 104 (e.g., the converter block 710 for each phase of the ACM) and a portion of the control system 110 (e.g., the local controller 704 for each phase of the ACM). The central controller 702 and local controllers 704a-c are communicatively coupled via a communication bus 709 (e.g., similar, or identical to communications interface 508 shown in FIG. 5). The communication bus 709 may include a collection of dedicated communication paths between each local controller 704 and the central controller 702, may include shared communication paths between the local controllers 704 and the central controller 702 (e.g., where communications include addressing information to identify an intended destination device), or a combination thereof.

Although FIG. 7 illustrates a three-phase ACM 706a, in some examples, the ACM 706a and one or more other ACMs 706n are single phase, split phase, or have more than three phases.

As noted, the central controller 702 and the local controllers 704 may communicate with each other in real time (e.g., each control cycle) both monitoring information (e.g., sensor data) and control information. For example, the local controllers 704 may determine and transmit to the central controller 702 electrical operational characteristics including one or more of V_{g,abc}, i_{g,abc}, and i_{L,abc}, and the central controller 702 may determine and transmit the control reference targets Ref_{abc} (e.g., which may be v_{c,abc}*, I_{L,abc}*, Or i_{o,abc}*) based on the received electrical operational characteristics. The local controllers 704 may further generate and transmit PWM control signals to their corresponding converter block 708. Each of the PWM control signals output by the local controllers 704 may indicate a duty cycle and/or a frequency for a PWM signal that drives a gate terminal of each power switching element of the converter block 708 or may be the PWM signal itself. Each converter block 708 may further include a respective gate driver for driving the power switching elements of the converter block, or the gate driver for a local converter block 710 may be considered part of the corresponding local controller 704.

In some examples, a state estimator is associated with each of the local controllers 704 to provide an estimation of one or more of the electrical operational characteristics for the phase associated with the local controller based on samplings of other electrical characteristics for the phase. For example, the state estimator may implement a Luenberger observer technique that estimates the switch side inductor current for a phase (also referred to herein as inductor current i_{L,abc}) based on the capacitor voltage (v_{c,abc}) and grid side inductor current (i_{o,abc}) for the phase. Use of a state estimator can reduce the number of sensors used in the system to provide the local controllers 704 with the electrical characteristics, thereby reducing costs and/or size of the motor circuitry.

In some embodiments, the hierarchical control system further incorporates one or both of harmonic injection, as described above, or MPC for active damping to mitigate resonance, as described below. In some embodiments, a power converter system has a non-isolated N-phase power converter and a control system that utilizes model predictive control (MPC). When used in a power converter system (e.g., the system 100 and 500), MPC may provide, for example, active resonance damping, improved dynamic performance, and/or leakage current attenuation capabilities.

A controller of the control system 700, such as the central controller 702 or the local controllers 704, implementing MPC may be referred to as an MPC controller. The MPC controller may be configured to determine electrical operational characteristics of the ACM 706a (e.g., characteristics for each phase of the converter), determine one or more control reference targets for the ACM 706a (e.g., a target per phase of the converter), and then generate control signaling, based on an MPC algorithm using the electrical operational characteristics and the control reference target. The control signaling may be applied to actuate the power switching elements of the ACM 706a to perform voltage conversion and active damping to mitigate resonance in filter circuit(s) of the ACM 706a (e.g., LC filters 612 shown in FIG. 6).

The MPC controller (or MPC controllers) may implement an MPC algorithm for each phase of the ACM 706a to generate the control signaling. As used herein, MPC can refer to a control algorithm that relies on or is aware of a system dynamic (e.g., implements or uses a dynamic model representing the converter under control) and predicts, through computation based on electrical characteristics of the converter and the dynamic model, input commands or reference values to control the system's behavior. Accordingly, MPC, as used herein, may refer to a model predictive control algorithm in a stricter use of the term (such as described in further detail below) as well as other dynamic prediction algorithms (e.g., a linear-quadratic regulator (LQR) control algorithm).

In one example, to implement the MPC algorithm for a particular phase, the MPC controller may, in each control period, solve a cost function using the electrical characteristics and the control reference target for that phase. By solving the cost function, the MPC controller can predict future steps of control signaling to actuate the power switching elements to control power on that phase of an AC voltage section of the power converter to trend towards the control reference target. The MPC controller may then generate the control signaling for that particular phase based on a first step of the future steps of control signals. Accordingly, in contrast to a PI control algorithm, the MPC algorithm derives an optimal duty cycle by processing a state variable and tracking error in a linear way with specific coefficients. Because no integration procedure is needed in MPC, the dynamic performance of MPC may be improved relative to a PI technique with less overshoot and higher tracking speed. Additionally, because MPC has higher control bandwidth, the MPC controller can provide an active damping term to mitigate (reduce or eliminate) LC or LCL resonance that may otherwise be present in a filter circuit in the AC section of the ACM 706a.

Power conversion systems (e.g., power conversion systems 100 shown in FIG. 1 or power conversion system 500 shown in FIG. 5) can control N-phase power converters (e.g., ACMs) of the system to achieve desired power efficiencies for the power conversion system for different loads or load configurations. In some examples, a control system 110, 502, 700 of the power conversion system can selectively enable N-phase power converters of a power conversion system to implement a cascaded power conversion (a cascaded mode). For example, in some examples, a first N-phase power converter can be enabled, and when the first N-phase power converter reaches or achieves a preselected load, the power conversion system can enable a second N-phase power converter to reach or achieve a greater power output and increase an efficiency. In some cases, a plurality of N-phase power converters can be enabled, and a DC load can be alternately applied to each of the plurality of enabled N-phase power converters to implement a cascaded power conversion in which an AC input signal is rectified to provide a DC signal to the DC load. In some cases, a control system 110, 502, 700 can operate N-phase power converters of a power conversion system in a round-robin mode where a round-robin selection algorithm is used to switch which N-phase power converter(s) of the plurality of enabled N-phase power converter receive and convert DC power periodically (e.g., every millisecond (ms), every 5 ms, every 10 ms, every 20 ms, every 50 ms, every 100 ms, etc.). The round-robin mode may be considered a sub-mode or particular example of the cascaded mode. In some cases, a control system 110, 502, 700 can operate N-phase power converters of a power conversion system in a parallel mode, rather than in a cascaded mode, distributing power conversion evenly or relatively evenly to each of the plurality of N-phase power converters at the same time (e.g., without switching between enabled N-phase power converters).

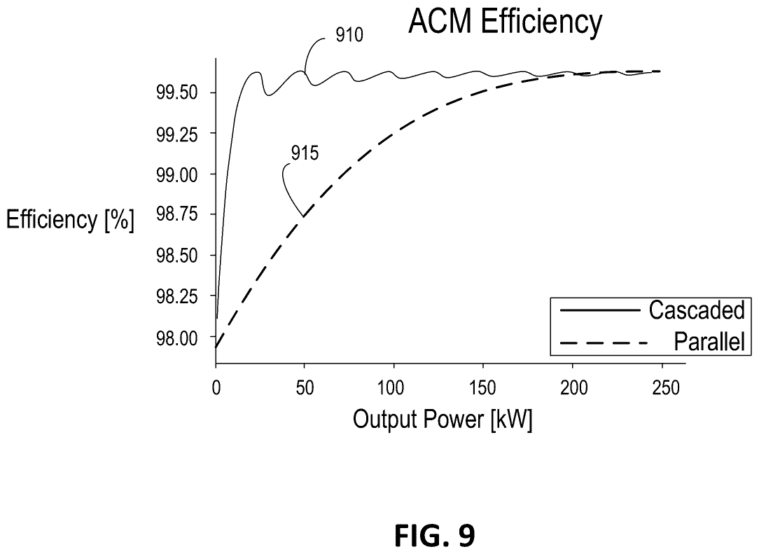

FIG. 8A illustrates a flow chart showing a process 800 for controlling a power converter system having networked power converters (a cascadable power converter system), according to some aspects. The process 800 can be implemented to provide power to AC or DC loads of a power converter system (e.g., power converter system 100 of FIG. 1, power converter system 500 of FIG. 5, etc.) by selectively enabling and driving switching elements of ACMs (e.g., N-phase power converters) of the power converter system. In some examples, the process 800 can be implemented to achieve greater system efficiencies (e.g., the smallest DC power input relative to an AC power output), conserve energy, extend lifetime of components of the system (e.g., extend the lifetime of individual ACMs), provide load balancing across ACMs of a power converter system, reduce a time to reach a steady state for a given system characteristics, provide failover for system components, etc. In these respects, a cascaded power converter system can provide improvements over a parallel power converter system that does not implement the selection of particular ACMs of a power conversion system, as illustrated in FIGS. 9-13. The process 800 can be implemented by control system such as, for example, all or a portion of control system 110 of FIG. 1, controls system 502 of FIG. 5, and control system 700 of FIG. 7, or another control system for a power converter system including ACMs. Additionally, portions of the process 800 can be performed by either or both of a central controller (e.g., central controller 702 of control system 700) and local controllers for individual ACMs, or for converter blocks of ACMs (e.g., local controllers 704a-c of control system 700 shown in FIG. 7). Further, while the process 800 is described with respect to ACMs of an EV, the discussion below is equally applicable to module N-phase power converters which may be used in other applications, including, for example, as a primary or backup power supply for a home, for redundant power systems of an AC grid, for charging batteries or powering other DC loads, etc.

At block 802, a control system can determine system characteristics of a power converter system having a plurality of N-phase power converters (e.g., power converter system 100 of FIG. 1, power converter system 500 of FIG. 5, etc.). System characteristics can be characteristics of the power converter system, of a DC source/load in communication with the power converter system, characteristics of an AC source/load in communication with the power converter system, and/or inputs received at an I/O interface in communication with the control system (e.g., I/O interface 112, shown in FIG. 1). In some cases, system characteristics can be derived from one or more other system characteristics. For example, a derived system characteristic can be a differential temperature, which can be a difference between a temperature measurement at one point of the power converter system and a temperature measured at another point of the power converter system. In some examples, system characteristics can be sensed values. For example, ACMs, DC power supplies, AC motors, or other components of a power conversion system can include sensors (e.g., temperature sensors, voltage sensors, current sensors, gyroscopes, accelerometers, etc.) to sense characteristics of the respective component, and provide sensed values to a control system. In some examples, system characteristics can be a mode of the system, a target value of the system, a user input, a load demand on the power converter, etc. Further, system characteristics can include electrical values (e.g., measured voltages, current, power at certain points along the system), thermal values (e.g., a temperature, a thermal flux, a differential temperature), a physical dynamics property (e.g., a speed, an acceleration value, a torque). In some cases, system characteristics include uptime values for components of the system.

For example, FIG. 8B illustrates an example of a sub-process for implementing block 802 of the process 800 for determining system characteristics of a power converter system. With respect to FIG. 8B, block 802 may be referred to as sub-process 802. In some examples, a control system (e.g., systems 110, 502, or 700) for a power converter system can implement all or a portion of the sub-process 802. Further, an order of steps performed is not limited to the sequence described here. At block 802a, the control system can determine one or more measured values of an ACM (e.g., ACM 208, 506, 706a, 706n) via one or more sensors (e.g., sensor(s) 111). The measured value(s) of the ACM may be one or more of the system characteristics or indicative of one or more of the system characteristics. For example, the control system can determine an AC or DC power output of an ACM from one or more measured values for voltage and/or current along the ACM using voltage and/or current sensor(s) (e.g., at AC terminals 610a-c or DC terminals 608 of FIG. 6). In some cases, the AC voltage output of one or more AC phases can be determined (e.g., from a voltage or current measured at one or more of interface terminals 610a-c of ACM 600 shown in FIG. 6). In some cases, the control system can determine an efficiency from a measured DC power input and a measured AC power output, or, when rectifying, from a measured AC power input and a measured DC power output. In some cases, temperature information from a temperature sensor may be received by the control system. For example, a temperature of the ACM can be sensed and provided to the control system using a temperature sensor. As another example, a thermal flux of the ACM can be determined from a measured temperature using a temperature sensor (e.g., a thermal flux sensor). In some examples, usage parameters of the ACM can be determined, including an uptime of the ACM (e.g., a total time of continuous operation of the ACM) or a total power output of the ACM over time. For example, the control system (e.g., a central or local controller thereof) can include one or more clocks or timers that track when an ACM is enabled and operating to convert power (e.g., when power switching elements of the ACM are being driven), and a running total of this time (the uptime) may be maintained in a memory of the control system for each ACM. Additionally, the control system (e.g., a central or local controller thereof) can include one or more current, voltage, and/or power sensors that track power output by the ACM, and a running total of this power output may be maintained in a memory of the control system for each ACM.

At block 802b, the control system can determine one or more measured values for AC and DC sources and/or loads. The control system may determine the measured value(s) via one or more sensors (e.g., sensor(s) 111). The measured value(s) for the AC and DC sources and loads may be one or more of the system characteristics or indicative of one or more of the system characteristics. For example, the control system can determine a load across each ACM by determining a load quantity or demand of an AC load and/or a DC load coupled to each ACM using a current, voltage, and/or power sensor at the respective AC or DC terminals (see, e.g., terminals 608 or 610 of FIG. 6). For example, a total torque of a motor can be sensed, or derived from sensed power characteristics (e.g., voltage, current, frequency, etc.). The control system can receive an angular speed of the motor, or an acceleration value, from a sensor (e.g., of the sensors 111). Further, the control system can determine an efficiency value from an AC power input into a motor compared to a total power output of a rotor of the motor, by executing an efficiency computation based on power data from sensors (e.g., of the sensors 111). In some cases, a temperature of the motor can be sensed and provided to the control system. A control system can also receive information about the DC battery from one or more sensors (e.g., of the sensors 111) including, for example, a voltage across terminals of the DC battery and a current produced by the battery. At block 802b, the control system can further determine a total charge of the battery (e.g., which can impact a decision to implement a charging mode or a traction mode of the system). The control system can estimate the total charge of the battery based on the voltage and/or current of the battery sensed by a sensor (e.g., of the sensors 111). In other embodiments, system characteristics can be received or determined regarding non-traction AC loads and provided to the control system.

At block 802c, the control system can receive inputs, including user inputs for the system. The input(s) may be one or more of the system characteristics or indicative of one or more of the system characteristics. For example, with reference to FIG. 1, the control system 110 may receive the inputs via the I/O interface 112. In some cases, the inputs can include a throttle signal received from an acceleration pedal of an EV an indicative of a throttle value. In some cases, the inputs include user-set desired target values and/or limits for system characteristics. For example, a user may specify a maximum speed, a maximum temperature, a maximum operating time for components, a maximum acceleration, etc. In some cases, the inputs (e.g., target values) can be programmed into a control system, and to receive the inputs, a processor of the control system can retrieve the target values from a memory of the control system. In some cases, the control system can receive a user input that indicates a desired mode including, for example, a charging mode, a traction mode (also referred to as a propulsion mode, where power is to be provided to a motor of an EV to propel the vehicle over land or though air or water), a V2X mode (e.g., wherein a DC battery of an EV or hybrid vehicle provides DC to DC or DC to AC power to downstream loads, which can include an AC power grid, other vehicles, etc.), a high-efficiency mode, a high-power mode, etc. The control system can generate target voltage and/or values from target values provided by a user or programmed into the system, and, ultimately, the target voltage/currents can be used by a central or local controller of the control system to generate control signals to control power switching components of ACMs of a power converter system. In some examples, the target values are determined based on characteristics of the system, such as, for example, voltage and current on a DC load or source, frequency or power factor correction on an AC load or source.

Returning to FIG. 8A, at block 804, the control system can determine a set of one or more N-phase power converters to be enabled from the plurality of N-phase power converters of the power converter system. For example, the control system may determine which ACMs (e.g., ACMs 208, 506, 706a, 706n) of the power converter system to be enabled. In some cases, determining which power converters (or ACMs) to be enabled can include determining a number of power converters to be enabled. As used herein, the terms ACMs and power converters may be used interchangeably, unless otherwise noted. The determination of which ACMs of a power converter system to enable can be based on the system characteristics determined at block 802. For example, if a throttle value from a user input increases, the control system may determine that a greater number of ACMs are to be enabled to provide more power by the converter system or to generate greater torque at an AC motor driven by the ACMs. In some cases, specialized ACMs of the power converter can be adapted for specialized loads (e.g., high-torque loads for an AC motor, high-efficiency loads, loads requiring greater AC frequency output, etc.), and the control system can decide to enable the specialized ACMs when system characteristics meet specific conditions.

FIG. 8C illustrates an example of a subprocess for implementing block 804, which may be implemented by a control system for a power converter system (e.g., systems 110, 502, or 700). With respect to FIG. 8C, block 804 may be referred to as sub-process 804. At block 804a, the control system can determine one or more power characteristics of the power converter system based on the system characteristics determined in block 802. The power characteristics may indicate or describe characteristics of the power that is to be output by the power converter system (e.g., overall, at each ACM, by each phase of the power converter or ACM, etc.) and may include various thresholds associated with each ACM or the power converter system (e.g., power output or demand level thresholds, temperature thresholds, usage parameter thresholds, etc.). For example, the control system can determine an AC voltage, current, and/or frequency (e.g., power characteristic(s)) used to drive a motor at a desired speed or torque (e.g., system parameter(s)), based on user input throttle values. For example, the controls system may receive a throttle signal as input (e.g., via an accelerator pedal of an EV), and may translate the throttle signal to the desired speed or torque (e.g., using a lookup table), and may translate the desired speed or torque to a desired AC voltage, current, and/or frequency (e.g., using a lookup table). In some examples, the control system may translate the throttle value directly to a desired AC voltage, current, and/or frequency (e.g., using a lookup table). In some examples, the control system may further base the determination of the desired AC voltage, current, and/or frequency on other system characteristics (e.g., present rotational speed of the motor, present speed or torque of the EV, present AC load, etc.) in addition to the throttle value. In some cases, the thresholds associated with each ACM or the power converter system may vary based on a mode of a device (e.g., electric vehicle) in which the converter is integrated. For example, in a first (sport driving) mode, the threshold(s) may be reduced so that more ACMs are brought online more quickly than a second (economy driving) mode, taking into consideration latency in the network. In some cases, the control system can determine a use case or application based on the system characteristics and can determine a power characteristic based on the use case or application. For example, a power converter system may be used to provide power to an AC grid from a DC source, or may be used to power a home, a workshop, or other loads. The control system may determine this use case based on the system characteristics, and then determine the power characteristic(s) for this use case (e.g., using a lookup table mapping use cases to power characteristics). The power characteristic(s) may be unique to the type of AC load being powered by the power converter system for the use case. In some examples, the power characteristic(s) may include a load demand of a load coupled to the power converter system to receive power (e.g., in kilowatts (kW)). In some cases, at block 804a, the control system can determine, as the power characteristic, an amount of AC power to be converted to DC power to charge a DC battery or an amount of DC power to be converted to AC power to drive an AC load (e.g., a load demand in terms of an instantaneous or average power level). The load demand may be an expected or estimated amount (e.g., derived based on other power characteristics or system characteristics) or may be measured (e.g., as described with respect to system characteristics).

At block 804b, the control system can determine ACMs eligible to be enabled. For example, specialized ACMs may be adapted to specialized loads, and the system can determine that certain ACMs of a plurality of ACMs of a power converter system are adapted to provide the power characteristic(s) determined at block 804a. For example, if, at block 804a, the control system determines that power is to be used to charge a DC battery (as indicated by the power characteristic(s)), the system may determine that one or more ACMs are eligible to perform the required conversion (e.g., one or more ACMs of the plurality of ACMs can be specialized charging ACMs). Similarly, if the control system determines that high power is desired or necessary to drive an AC motor requiring high torque (e.g., above a threshold, such as, e.g., when accelerating an EV), the control system can determine that one or more ACMs of a plurality of ACMs have characteristics and capabilities matching the desired power output.

In some cases, an eligibility of an ACM can be determined based on system characteristics other than power characteristics. For example, a system can determine ACM eligibility to convert power to drive one or more loads based on a heat or thermal flux of the ACM. In some cases, a system can determine that ACMs are eligible to be enabled if a sensed temperature of the ACM is below a maximum threshold temperature. In some cases, the control system can perform load balancing across ACMs in order to extend the life of each ACM and can distribute load across ACMs to provide relative uniformity of usage for each ACM. Accordingly, in some cases, the control system can determine ACMs to be eligible for enablement based on a usage parameter (e.g., uptime or total power output of an ACM). For example, the control system can track an uptime, or a total power output of ACMs over time, and can determine that an ACM is eligible or ineligible based on its uptime or usage over a certain time window or total uptime or usage of the ACM. For example, an ACM that has been heavily used recently or over its lifetime, as determined by comparing its usage parameter(s) to respective threshold(s), may be determined to be ineligible. For example, when an ACM has a total uptime over the previous ten minutes, hour, day, or lifetime that exceeds a time threshold, the ACM may be determined to be ineligible. Similarly, when an ACM has a total power output over the previous ten minutes, hour, day, or lifetime that exceeds a power threshold, the ACM may be determined to be ineligible. In further examples, the control system may rank the usage parameters of the ACMs and determine that the ACMs with the highest usage (e.g., over the least ten minutes, hour, day, lifetime) may be ineligible.

In some examples, an ACM may be determined to be ineligible when the ACM is experiencing a fault or failure. For example, each ACM may output a health signal indicative of an operational health of the ACM (e.g., whether the ACM is operational or in a fault state) to the control system. The control system may determine an ACM is ineligible when a health signal received by the control system indicates that the ACM is in a fault state and/or when a period of time has lapsed in which the control system has not received a health signal from the ACM indicating that the ACM is operational. Each ACM may output the health signal periodically (e.g., as a heartbeat signal), may output the health signal in response to a change in health status (e.g., from operational to fault state, or from fault state to operational), and/or may output the health signal in response to a request from the control system for the health signal. In some examples, an eligibility of one or more ACMs to drive an AC load can be determined based on any system characteristic determined at block 802 of process 800, or on any power characteristic determined at block 804a.

At block 804c, the system can further determine a number of ACMs to enable. For example, in some cases, a single ACM is sufficient to convert power for a given load. In other examples, however, a system may desire or require additional power, or may desire or require that power be delivered to AC loads at a higher rate than a single ACM can or is desired to perform. As power is a product of voltage and current, and AC loads can reduce current by increasing a resistance, increasing power output of a power converter can include enabling specialized ACMs to drive higher current, or increasing a number of ACMs to be enabled. The number of ACMs can depend on a sequence of ACMs to be enabled. For example, achieving a power output within a time threshold may include enabling certain ACMs in a sequential fashion, rather than enabling all ACMs simultaneously.

In some cases, a cascaded control process can continually cycle through enabled ACMs to iteratively provide power from each of the ACMs, in a round-robin mode. In some examples, a first ACM of the enabled ACMs can receive and convert a DC input voltage at a first point in time, and after a given interval from the first point in time, DC power can cease to flow through the first ACM, and instead a second ACM can receive and convert the DC input voltage. Accordingly, in the round-robin mode implementing a round-robin selection algorithm in a power converter system with four ACMs, the control system may: (i) in a first time period, enable a first ACM and disable the other three ACMs; (ii) in a second time period, enable a second ACM and disable the other three ACMs; (iii) in a third time period, enable a third ACM and disable the other three ACMs; (iv) in a fourth time period, enable a fourth ACM and disable the other three ACMs; (v) in a fifth time period, return to enable the first ACM and disable the other three ACMs, and so on. The control system may cycle to the next ACM after a predetermined time period, or based on a system characteristic, such as a temperature of the enabled ACM reaching a switching threshold. In some examples, in each cycle of the round-robin mode, two or more ACMs are enabled, rather than just one ACM as described in the four ACM example. For example, returning to an example power converter system with four ACMs, the control system may alternate between enabling the first and second ACM and then enabling the third and fourth ACM. In another example power converter system with four ACMs, the control system may enable the first and second ACM, then the second and third ACM, then the third and fourth ACM, then the fourth and first ACM, and so on. The number of enabled ACMs can depend on a frequency at which a cascading control system cycles through enabled ACMs. Thus, a number of ACMs to be enabled can be different based on whether the ACMs are operated in a parallel mode, or in a cascaded mode.

In some embodiments, a number of ACMs to be enabled can be based on any system characteristic determined at block 802 of process 800, or on any power characteristic determined at block 804a. In some cases, system characteristics can indicate an increased load, or increased power requirement, and the system can determine to enable additional ACMs to meet the increased demand. Similarly, system characteristics can indicate a decreased load, and fewer ACMs can be enabled in response.

In some cases, a number of ACMs to be enabled can be based on a present load on the system to increase an efficiency of power conversion. For example, FIG. 9 illustrates a chart illustrating an efficiency of power conversion at various output powers levels for different operating modes of an ACM. The chart shows a comparison between the efficiency of a power conversion of an ACM operating in a cascaded mode (curve 910) and in a parallel mode (curve 915). In the cascaded mode, as the output power increases (e.g., with an increased load), additional ACMs are enabled. In this way, fewer ACMs are enabled for lower power output levels of the system, which enables the system to operate at higher efficiency. Each time a further ACM is enabled, the efficiency dips, and then returns up to higher efficiency as the output power increases. In contrast, in the parallel mode, when each of the ACMs is enabled throughout the illustrated operating curve 915, the efficiency of the power conversion generally increases as power output increases. The two curves 910 and 915 become generally similar as the power output increases (e.g., around 175-250 kW in the graph). Accordingly, in some examples, the control system may switch from cascaded mode to parallel mode (e.g., at 150 KW) when the potential efficiency gain is less significant and other benefits may be achieved, such as improved thermal performance. For example, six ACMs operating at 83% load may have improved thermal performance relative to five ACMs operating at 100% load, while the efficiency gains of having only five ACMs operating at 100% load relative to six ACMs operating at 83% load are not as significant or important of a design consideration. FIG. 9 is further discussed with respect to TABLE I below.

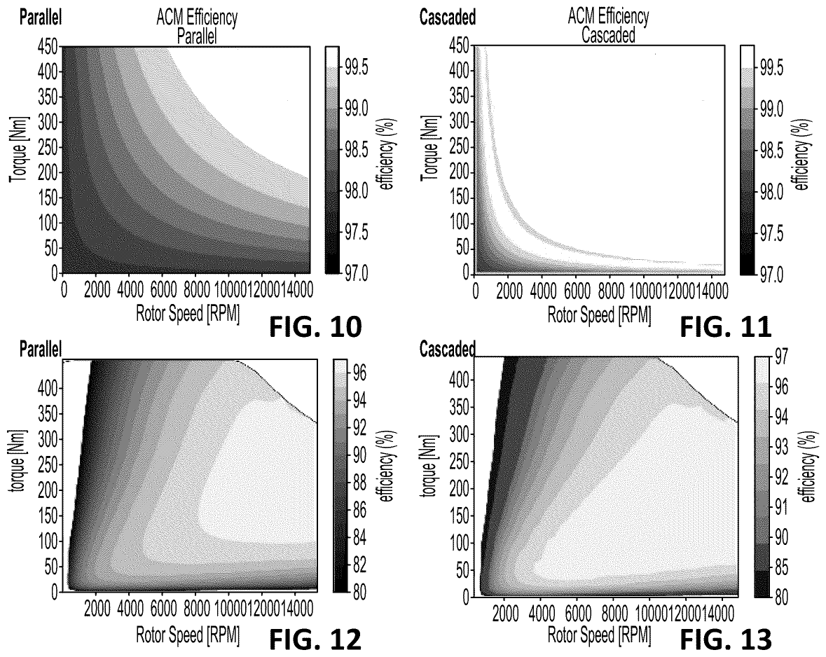

Referring back to FIG. 8C, at block 804d, a mode of operation for the ACMs (e.g., parallel or cascaded) can be selected. The mode of operation for the ACMs may be selected based on one or more system characteristics determined in block 802. For example, the control system may determine to enter a parallel mode based on a load on the power converter being above a threshold, a requested torque for a motor driven by the ACMs being above a threshold, a requested speed for the motor being above a threshold, an output power of the power converter being above a threshold, or based on a user input indicating the desired operating mode. Similarly, for example, the control system may determine to enter a cascaded mode based on a load on the power converter being below a threshold, a requested torque for a motor driven by the ACMs being below a threshold, a requested speed for the motor being below a threshold, an output power of the power converter being below a threshold, or based on a user input indicating the desired operating mode. In some examples, by switching operating modes, the power converter may improve power conversion efficiency, improve thermal performance of the ACMs, distribute stress or wear on ACMs more evenly or in a desired manner, or the like. For example, FIGS. 10-13 are charts showing empirically determined efficiency values for a motor driven by power converters operated in parallel or cascaded mode. FIG. 10 illustrates efficiencies of a motor at values of torque in Newton-meters, and rotor speed in radians per minute with ACMs operated in parallel mode, while FIG. 11 illustrates efficiencies of a motor at values of torque in Newton-meters, and rotor speed in radians per minute with ACMs operated in cascaded mode. As shown, ACMs operating in cascaded mode can provide greater power efficiencies at a wider range of torque values and rotor speeds. In some examples, a control system can reference empirical data (e.g., test data used to produce the efficiency charts of FIGS. 10 and 11) and can perform a comparison between efficiencies for a given desired rotor speed and torque of ACMs operated in parallel mode or cascaded mode and can select an operating mode that results in a greater power efficiency for the given rotor speed and torque. In some cases, predicted efficiencies can be calculated from a control system, rather than by performing a lookup. FIGS. 12 and 13 illustrate additional efficiency graphs for ACMs operated in parallel and cascaded modes respectively, with the efficiency value being a combined efficiency of power converters and an AC motor. In some cases, an operating mode can be selected to produce a greater combined efficiency of ACMs and a motor.

At block 804e, the system can determine specific ACMs to enable. The determination of which ACMs to enable can be based on any or all of the determinations at blocks 804a-d. For example, in some examples, a plurality of ACMs can include seven ACMs, and six of the seven ACMs can be eligible to drive an AC load, based on power characteristics of the system (e.g., power characteristics determined at block 804a). The control system can determine that only three ACMs are required to drive the AC load, and therefore, three of the six eligible ACMs can be selected. In some cases, as described above, ACMs to be selected can be based on a round-robin selection algorithm, wherein a system cycles through ACMs in a particular order and enables the next eligible ACM in a list of eligible ACMs. In some cases, ACMs can be selected for enablement based on relative characteristics of the ACM. For example, a system can determine to enable an eligible ACM based on a heat comparison (e.g., in choosing between two eligible ACMs to be enabled, the system can choose the ACM with a lower sensed temperature). In some cases, the system can select an eligible ACM to be enabled based on a comparison of usage between the eligible ACMs. For example, for all eligible ACMs, the system can determine which ACMs have the least total usage or uptime, and can select those ACMs to be enable, to ensure uniformity of wear across ACMs. In some cases, ACMs to be enabled can be randomly selected.

In some cases, at block 804e, the system can determine an enablement sequence for the ACMs. For example, the system may determine to enable the ACMs in a cascaded mode, and individual ACMs can be enabled at different points in time. In some cases, for example, the system can enable a first ACM at a first point in time, and a second ACM in a second point in time. For example, a system may be set to achieve a certain steady state (e.g., a target power output) and enabling ACMs in a cascaded mode can reduce a time to achieve a steady state for a given steady state outcome. In some cases, a first ACM to be enabled can be a specialized ACM. For example, one or more ACMs of the plurality of ACMs can be adapted for higher power outputs and can produce a power output for acceleration of an EV, and subsequently enabled ACMs can be enabled to provide power outputs when lower power output demands are present. In some cases, a system can operate ACMs in parallel, and all eligible ACMs can be enabled substantially simultaneously. In the event that one or more ACMs of the system are ineligible, with all parallel ACMs enabled, the power converter system may be operating at a reduced capacity. Nevertheless, the power converter system implementing the process 800 may be referred to as self-healing as the control system disables the failed ACM (e.g., determined to be ineligible based on a health signal or lack of a health signal from the ACM in block 804b) and controls the remaining eligible ACMs (or a subset thereof) to provide power conversion.

In some examples, in block 804e, the system can send a control signal to each ACM to indicate whether the ACM is enabled or disabled. For example, with reference to FIG. 7, the central controller 702 can send an enable signal to each local controller 704 of each ACM 706 indicative of whether that ACM is enabled or disabled. In some examples, the central controller 702 can send the enable signals as separate signals on bus 709. In other examples, the central controller 702 can encode the enable signals in the reference signals Refn communicated to the local controllers 704 (e.g., by using a null value, a sequence of values, or another predetermined value to indicate a disable command, and by using a valid reference value to indicate an enable command). For example, each enabled ACM may receive a reference signal for each phase (e.g., Refₐ, Ref_{b}, Ref_{c} in a three-phase power converter system), where the local controllers of a particular phase of the enabled ACMs may each receive the same reference signal (e.g., phase A local controllers of enabled ACMs each receive Refₐ), whereas local controllers of disabled ACMs receive a value along a reference command input indicative of the disable command.

In some examples, one or more of the blocks 804a, 804b, 804c, or 804d of the sub-process 804 may be bypassed or executed in another order. For example, in some cases, one of the blocks 804a, 804b, 804c, or 804d may be determinative as to which ACMs to enabled regardless of the other blocks. For example, the control system may execute block 804d and determine that the mode of operation is parallel based on a system characteristic determined in block 802 of FIG. 8A and, as a result, may enable all ACMs or a set of ACMs predetermined to be selected for parallel mode. Accordingly, the control system may execute block 804d before blocks 804a-c, and may determine to bypass blocks 804a-c and to proceed to block 804e. In other examples, the control system may execute block 804c before 804b or 804d, or may execute block 804d between 804b and 804c or between 804a and 804b. Regardless of the particular order of particular blocks fo the sub-process 804 executed, through execution of the sub-process 804, the control system determines the set of power converters (or ACMs) to be enabled power converters based on the system characteristics (determined in block 802 of FIG. 8A).

Returning back to FIG. 8A, at block 806, the control system can drive switching elements of the enabled power converters to produce an output signal. In some examples, the switching elements are driven to convert DC power (e.g., from battery 102 of power converter system 100 shown in FIG. 1) to AC power to drive AC loads. In some cases, for example, the AC load can be a traction load (e.g., an AC motor of an EV), a load providing AC power to an AC grid, providing power for a home or for commercial applications, etc. In some cases, the switching elements can be driven to convert AC power to DC power (e.g., for charging the battery). The switching elements can be driven with PWM controls signals in accordance with instructions from a controller (e.g., from either or both of a central controller 702 and a local controller 704, as illustrated in FIG. 7). For example, the switching elements can be driven to produce an output voltage of RMS 120 V at a frequency of 60 hz at each phase of AC output of an ACM, or another output voltage or frequency. For example, with reference also to FIG. 7, to drive the switching elements at block 806, the central controller 702 may provide (or continue to provide) control reference targets (Ref_{abc}) to each of the enabled power converters (i.e., enabled ones of ACMs 706a, 706n). Each local controller 704 of each of the enabled power converters may then drive the converter block 708 associated with that local controller 704 with a PWM signal, which drives the power switching elements of that converter block 708. Additionally, each local controller 704 may provide electrical operational characteristics back to the central controller 702 via bus 709, which the central controller 702 may the use to update the control reference targets (Ref_{abc}).

Because of the sinus output, for example, the output of each ACM does not need to be perfectly timed or in synchronization with one another. For example, the PWM signals driving the power switching elements of the ACMs may vary slightly and not have edges that match precisely, and the power converter system will perform power conversion as intended (e.g., without faults or failures due to misaligned PWM signal edges). Accordingly, the particular ACMs enabled and disabled may be changed over time, with some previously disabled ACMs being brought online and/or some previously enabled ACMs being brought offline on-the-fly safely, quickly, and effectively.

As indicated by the arrow from block 806 to block 802, the process 800 can be performed continuously by the control system of the power conversion system and can, therefore, respond to changes in system characteristics (e.g., when a throttle input value is changed, when a heat of an ACM increases, when a power efficiency value is reached, when a threshold load capacity of an ACM is reached, etc.) to enable and drive switching elements of different ACMs.

In some cases, while executing a particular instance of block 806, the power converters identified as the enabled power converters and being driven by the control system remains static until the control system loops back to block 802 and a change in system characteristics causes a resulting change in the selection of enabled power converters. In some examples, while executing a particular instance of block 806, the power converters identified as the enabled power converters (and being controlled to convert power) may cycle periodically according to a round robin mode, as discussed further above. In some examples, to change the enabled power converters to implement the round robin mode, the control system loops back through blocks 802 and 804 to identify the next power converters to be enabled according to the round robin mode.

In one example of the process 800, in block 802, a control system (e.g., control system 110, 502, 700) receives an initial input (e.g., torque or throttle value) to start controlling a power converter (e.g., power converter 104) including ACMs (e.g., ACMs 208, 506, 706) to drive a motor (e.g., motor 106) coupled to the power converter. The control system, also in block 802, may determine that the present output power of the power converter is 0 or negligible. Accordingly, in block 802, the control system may receive the initial input and present output power as system characteristics (see also, e.g., blocks 802c and 802a of FIG. 8B). In block 804, the control system may compare the present output power to one or more power thresholds mapped to ACMs. The present output power may serve as a power characteristic (see block 804a) and the power thresholds may also be examples of power characteristics (see block 804a). For example, with reference to FIG. 9 and Table I below, an example of the power converter 104 may include ten ACMs, each associated with an output power threshold (e.g., in kilowatts (kW)). When the control system determines that the present output power is above an ACM's associated output power threshold, the control system may determine to enable that ACM. For example, initially, the power converter may have present output power of 0 kW. In this case, the control system may determine to enable ACM 1 (and leave ACMs 2-10 disabled, as the present output power is below their associated output power threshold). Then, in block 806, the control system may drive the ACM 1 (the ACM that the control system determined to enable in block 804). As the control system controls the ACM to invert DC power and drive the coupled motor, the power may increase (see, e.g., the cascaded curve 910 of FIG. 9). The control system may loop back through blocks 802-806. In a future pass through block 802, the control system may determine that the present power output of the power converter has reached 26 kW. In other words, the control system may determine a change in the power demand for the power converter system (e.g., relative to the previous pass through blocks 802-806). In this case, in block 804, the control system may determine to enable ACM 1 and ACM 2 (leaving ACMs 3-10 disabled) because the present power output exceeds the threshold ACM 2 (and of ACM 1). Then, in block 806, the control system may control the ACMs 1 and 2 to convert DC power to AC to drive the motor. This process may continue as the control system loops through the blocks 802-804 and the output power fluctuates up (resulting in enabling of additional ACMs) and down (resulting in enabling of fewer ACMs). For example, when the control system determines that the present output power is 126 kW, the control system may determine to enable ACMs 1-6.

As illustrated in FIG. 9, the efficiency of the power converter via cascaded control (curve 910) is improved relative to parallel control (curve 915) for a substantial portion of the output power range.

Table 1 includes two output power threshold mappings that map ACMs to power output (or load demand) thresholds. In the output power threshold mapping of the left column, each threshold increments by 25 kW and is associated with one additional ACM. In the right column (Alternate Output Power Threshold), the thresholds are mapped such that, at 150 KW, the remaining ACMs 7-10 are all enabled to switch to a parallel mode. Use of parallel mode at this output power may improve thermal performance of the system, at the expense of a modest drop in efficiency.

TABLE I

| | Output Power | Alternate Output |
|---|---|---|
| ACM # | Threshold (kW) | Power Threshold (kW) |
| ACM 1 | 0 | 0 |
| ACM 2 | 25 | 25 |
| ACM 3 | 50 | 50 |
| ACM 4 | 75 | 75 |
| ACM 5 | 100 | 100 |
| ACM 6 | 125 | 125 |
| ACM 7 | 150 | 150 |
| ACM 8 | 175 | 150 |
| ACM 9 | 200 | 150 |
| ACM 10 | 225 | 150 |

The particular number of ACMs and thresholds are selected and shown merely to illustrate an example of cascaded control of a power converter. In other examples, more or fewer ACMs are employed, larger or smaller thresholds are employed, non-uniform thresholds are chosen (e.g., when ACMs of non-uniform configurations and ratings are used), multiple ACMs are associated with a single threshold (e.g., earlier in the mapping than 150 KW). In some examples, different thresholds and/or numbers of ACMs to be online are changed based on a mode of operation fo the device in which the power converter is integrated. For example, in a first (sport driving) mode, the thresholds may be lower than in a second (economy driving) mode, and/or more ACMs may be brought on at lower thresholds in the first mode (e.g., as in the right column) than in the second mode (e.g., as in the left column). In some examples, the ACM # does not identify a particular ACM but, rather, a quantity of ACMs to be enabled in a round-robin mode, as described above, or selected via another selection criteria (e.g., from those ACMs deemed eligible in block 804b of FIG. 8C). In other examples, the ACM # does identify a particular ACM. In such cases, for example, ACMs may be nonuniform and customized (specialized) for particular output power ranges, for example, with components (e.g., capacitors, inductors, FETs, etc.) having higher power ratings to handle additional load and stress (e.g., to accelerate an EV and/or high torque application) and with lower power ratings to handle lower loads and stress (e.g., to maintain EV speed and/or low torque application).

As noted, the power converters described herein (e.g., the power converter 104, 500, 600) may be bidirectional. Accordingly, while the power converter may at some instances operate in a traction or propulsion mode to generate an AC signal to drive a motor, the power converter may operate at other instances in a charging mode and rectify an AC signal to generate a DC signal to charge a battery (e.g., the battery 102, HVDC 504, battery 602, etc.). For example, in some passes through the process 800 of FIG. 8A, the control system may determine in block 802 that the power converter is to be in a charging mode (e.g., as described with respect to block 802c of FIG. 8B). Then, in block 804, the control system may determine the power converters to be enabled for the charging mode. In some examples, the ACMs 506 may include a dedicated charging ACM, which may be determined to be the power converter to be enabled. In other examples, one or more other ACMs of the ACMs 506 are selected by the control system to be enabled for the charging mode, using a similar process as described with respect to subprocess 804 of FIG. 8C. In block 806, the control system may drive switching elements of the enabled power converters to convert AC power received via AC terminals to DC power, and provide the DC power to DC terminals connected to the battery.

In some embodiments, rather than provide an AC/DC rectification or DC/AC inversion, the networked power converters described herein provide DC/DC conversion. For example, with reference to FIG. 1, in place of or in addition to the motor 106 or the grid 108, a DC network is provided and connected to the power converter 104. Likewise, in FIG. 5, in place of the motors 516a,b, a DC network is provided and connected to all or a portion of the ACMs 506a-d. In such examples, the power converter 104 (or ACMs 506) may convert DC power received from the battery 102 (or HVDC 504) to boost or buck the DC voltage level and provide the converted DC power to the DC network; or, the power converter 104 (or ACMs 506) may convert DC power received from the DC network to boost or buck the DC voltage level and provide the converted DC power to the battery 102 (or HVDC 504) (e.g., for charging). In these examples, the ACMs 506 may be controlled using a similar process as described with respect to FIG. 8, except to provide DC/DC conversion. For example, a power converter system (e.g., power converter system 100 of FIG. 1, power converter system 500 of FIG. 5, etc.) may perform the process 800 to selectively enable and drive switching elements of ACMs (e.g., N-phase power converters) of the power converter system to provide DC/DC conversion. For example, in block 806, instead of driving switching elements of enabled power converter to converter power from AC to DC or from DC to AC, the driving of the switching elements is controlled to convert power from DC of a first voltage to DC of a second voltage that is higher (in the case of boosting) or lower (in the case of bucking). As a result, ACMs may be controlled in a cascaded manner, which can provide improvements over a parallel power converter system that does not implement the selection of particular ACMs of a power conversion system.

In some embodiments, the networked power converters described herein provide multiple stages of power conversion. For example, with reference to FIG. 1, the power converter may include a DC/DC conversion stage and an AC/DC conversion stage, and may operate bidirectionally. To implement multiple stages, with reference to FIG. 5, certain ACMs 506 may be assigned to the DC/DC conversion stage (one or more DC/DC ACMs) and certain ACMs 506 may be assigned to the AC/DC conversion stage (one or more AC/DC ACMs). Additional hardwired connections or selectively controllable contactors may be provided to provide a connection of the DC/DC ACM(s) to the HVDC 504, a connection between the DC/DC ACM(s) and the AC/DC ACM(s), and a connection of the AC/DC ACM(s) and an AC load or source (e.g., the motor 516a, the motor 516b, and/or an AC grid). In a charging mode, the AC/DC ACM(s) may receive AC power from an AC source (e.g., the motor 516a, the motor 516b, and/or an AC grid), rectify the AC power to provide DC power (e.g., using the process 800 of FIG. 8) to the DC/DC ACM(s), which may boost or buck the DC power to a voltage suitable or desired for the HVDC 504. In discharging mode, the DC/DC ACM(s) may receive DC power from the HVDC 504, which may boost or buck the DC power to a voltage suitable or desired for the AC/DC ACM(s), the AC/DC ACM(s) may invert the DC power to provide AC power (e.g., using the process 800 of FIG. 8) to the AC load (e.g., the motor 516a, the motor 516b, and/or an AC grid). The number of ACMs assigned to each of the DC/DC conversion stage and to the AC/DC conversion stage may be determined by the control system 502 (e.g., by executing the process 800 for each stage).

Specific embodiments have been shown by way of example in the drawings and have been described in detail herein. However, the disclosure and claims are not intended to be limited to the particular forms disclosed. Thus, the application is intended to cover all modifications, equivalents, and alternatives falling within the spirit and scope of the disclosure as defined by the following appended claims.

### FURTHER EXAMPLES

Example 1: A method, apparatus, and/or non-transitory computer-readable medium storing processor-executable instructions for a power converter system for an electric vehicle, comprising: direct current (DC) terminals to connect to a battery; alternating current (AC) terminals to connect to a motor; a plurality of N-phase power converters, each N-phase power converter including, for each of N phases of the N-phase power converter: power switching elements connected to the DC terminals, and an LC filter connected to the power switching elements and to the AC terminals; a converter control system including at least one electronic processor, the converter control system configured to: determine at least one system characteristic of the power converter system, determine, based on the at least one system characteristic, a set of one or more of the plurality of N-phase power converters to be enabled power converters, and drive the power switching elements of the enabled power converters to convert DC power received via the DC terminals to AC power to output via the AC terminals.

Example 2: The method, apparatus, and/or non-transitory computer readable medium of Example 1, The power converter system of claim 1, wherein the at least one system characteristic includes a thermal flux of at least one of the one or more N-phase power converters.

Example 3: The method, apparatus, and/or non-transitory computer readable medium of any of Examples 1 or 2, The power converter system of claim 1, wherein the at least one system characteristic includes a throttle signal received at the converter control system.

Example 4: The method, apparatus, and/or non-transitory computer readable medium of any of Examples 1 to 3, wherein the at least one system characteristic include at least one selected from the group of a power output at the AC terminals, a load across each N-phase power converter of the plurality of N-phase power converters, and a power characteristic at each N-phase power converter of the plurality of N-phase power converters.

Example 5: The method, apparatus, and/or non-transitory computer readable medium of any of Examples 1 to 4, wherein the at least one system characteristic includes a usage parameter of one or more of the N-phase power converter.

Example 6: The method, apparatus, and/or non-transitory computer readable medium of any of Examples 1 to 5, wherein the converter control system is further configured to: determine, in response to a change in power demand, an updated set of N-phase power converters to be enabled power converters.

Example 7: The method, apparatus, and/or non-transitory computer readable medium of any of Examples 1 to 6, wherein the change in power demand is an increase in power demand, and the updated set of N-phase power converters includes a greater number of N-phase power converters than the number of N-phase power converters in the set of one or more N-phase power converters.

Example 8: The method, apparatus, and/or non-transitory computer readable medium of any of Examples 1 to 6, wherein the change in power demand is a decrease in power demand, and the updated set of N-phase power converters includes a lesser number of N-phase power converters than the number of N-phase power converters in the set of one or more N-phase power converters.

Example 9: The method, apparatus, and/or non-transitory computer readable medium of any of Examples 1 to 8, wherein each N-phase power converter of the plurality of N-phase power converters is substantially similar to the other N-phase power converts of the plurality of N-phase power converters.

Example 10: The method, apparatus, and/or non-transitory computer readable medium of any of Examples 1 to 8, wherein a first N-phase power converter of the plurality of N-phase power converters is a specialized power converter having a higher power rating than at least one other of the plurality of N-phase power converters, and wherein the converter control system is further configured to determine to enable the first N-phase power converter based on a power characteristic of the plurality of N-phase power converter.

Example 11: The method, apparatus, and/or non-transitory computer readable medium of any of Examples 1 to 10, wherein, to determine the set of one or more of the plurality of N-phase power converters to be enabled power converters, the converter control system is further configured to select an operating mode from a plurality of operating modes based on one or more of the at least one system characteristic.

Example 12: The method, apparatus, and/or non-transitory computer readable medium of Example 11, wherein the plurality of operating modes includes a parallel operating mode and a cascaded operating mode.

Example 13: The method, apparatus, and/or non-transitory computer readable medium of any of Examples 1 to 12, wherein the converter control system is configured to determine the sat least one system characteristic at predetermined intervals and, wherein, in response to a change in the at least one system characteristic, the converter control system determines an updated set of one of more of the plurality of N-phase power converters to be enabled power converters.

Example 14: The method, apparatus, and/or non-transitory computer readable medium of any of Examples 1 to 13, wherein the converter control system is configured to: determine an N-phase power converter of the set of one or more of the plurality of N-phase power converters is in a fault state; determine an updated set of one of more of the plurality of N-phase power converters to be enabled power converters, wherein the updated set does not include the N-phase power converter that is in the fault state; and drive the power switching elements of the enabled power converters to convert DC power received via the DC terminals to AC power to output via the AC terminals.

Example 15: The method, apparatus, and/or non-transitory computer readable medium of any of Examples 1 to 14, wherein the AC terminals are coupled to at least one selected from a group of an external power network and an AC motor, and wherein the DC terminals connect to the battery via a DC/DC power converter comprising power switching elements connected to the DC terminals, and an LC filter connected to the power switching elements and to battery terminals.

Example 16: The method, apparatus, and/or non-transitory computer readable medium of any of Examples 1 to 15, wherein the plurality of N-phase power converters includes a dedicated charging power converter.

Example 17: The method, apparatus, and/or non-transitory computer readable medium of any of Examples 1 to 16, wherein the determination of the N-phase power converters to be included in the set of one or more N-phase power converters is made based on a round-robin selection algorithm.

Example 18: A method, apparatus, and/or non-transitory computer-readable medium storing processor-executable instructions for a power converter for an electric vehicle, comprising: determining at least one system characteristic of a power converter system, the power converter system including direct current (DC) terminals to connect to a battery, alternating current (AC) terminals to connect to a motor, and a plurality of N-phase power converters, each N-phase power converter including, for each of N phases of the N-phase power converter, power switching elements connected to the DC terminals and including an LC filter connected to the power switching elements and to the AC terminals; determining, based on the at least one system characteristic, a first set of one or more of the plurality of N-phase power converters to be enabled power converters; and driving the power switching elements of the enabled power converters to convert DC power received via the DC terminals to AC power to output via the AC terminals.

Example 19: The method, apparatus, and/or non-transitory computer readable medium of Example 18, further comprising: selecting, based on the at least one system characteristic, an operating mode of a plurality of operating modes of the N-phase power converters, the plurality of operating modes including a parallel mode and a cascading mode; wherein the selection of the operating mode is performed based on the at least one system characteristic, and wherein driving the power switching elements includes implementing the selected operating mode.

Example 20: The method, apparatus, and/or non-transitory computer readable medium of any of Examples 18 or 19, further comprising: determining updated system characteristic of the power converter system; and determining, based on the updated system characteristic, a second set of N-phase power converters of the plurality of N-phase power converters to be enabled power converters.

Example 21: The method, apparatus, and/or non-transitory computer readable medium of any of Examples 18 to 20, wherein the updated system characteristic of the power converter system are indicative of an increased power demand and wherein the second set of N-phase power converters includes a higher number of N-phase power converters than the first set of one or more of the plurality of N-phase power converters.

Example 22: The method, apparatus, and/or non-transitory computer readable medium of any of Examples 18 to 21, wherein the first set of N-phase power converters include a first N-phase power converter and a second N-phase power converter, and wherein driving the power switching elements of the second N-phase power converter does not start until the first N-phase power converter reaches a first load threshold.

What is claimed is:

1. A power converter system for an electric vehicle, the system comprising:
direct current (DC) terminals to connect to a battery;
alternating current (AC) terminals to connect to a motor;
a plurality of N-phase power converters, each N-phase power converter including, for each of N phases of the N-phase power converter:
power switching elements connected to the DC terminals, and
an LC filter connected to the power switching elements and to the AC terminals; and
a converter control system including at least one electronic processor, the converter control system configured to:
determine at least one system characteristic of the power converter system,
determine, based on the at least one system characteristic, a set of one or more of the plurality of N-phase power converters to be enabled power converters, and
drive the power switching elements of the enabled power converters to convert DC power received via the DC terminals to AC power to output via the AC terminals.

2. The power converter system of claim 1, wherein the at least one system characteristic includes a thermal flux of at least one of the set of one or more N-phase power converters.

3. The power converter system of claim 1, wherein the at least one system characteristic includes a throttle signal received at the converter control system.

4. The power converter system of claim 1, wherein the at least one system characteristic include at least one selected from a group of a power output at the AC terminals, a load across each N-phase power converter of the plurality of N-phase power converters, and a power characteristic at each N-phase power converter of the plurality of N-phase power converters.

5. The power converter system of claim 1, wherein the at least one system characteristic include a usage parameter of the plurality of N-phase power converters.

6. The power converter system of claim 1, wherein the converter control system is further configured to: determine, in response to a change in power demand, an updated set of N-phase power converters to be enabled power converters.

7. The power converter system of claim 6, wherein the change in power demand is an increase in power demand, and the updated set of N-phase power converters includes a greater number of N-phase power converters than the set of one or more N-phase power converters.

8. The power converter system of claim 6, wherein the change in power demand is a decrease in power demand, and the updated set of N-phase power converters includes a lesser number of N-phase power converters than the set of one or more N-phase power converters.

9. The power converter system of claim 1, wherein each N-phase power converter of the plurality of N-phase power converters is substantially similar to each other N-phase power converter of the plurality of N-phase power converters.

10. The power converter system of claim 1, wherein a first N-phase power converter of the plurality of N-phase power converters is a specialized power converter having a higher power rating than at least one other of the plurality of N-phase power converters, and wherein the converter control system is further configured to determine to enable the first N-phase power converter based on a power characteristic of the plurality of N-phase power converters.

11. The power converter system of claim 1, wherein, to determine the set of one or more of the plurality of N-phase power converters to be enabled power converters, the converter control system is further configured to select an operating mode from a plurality of operating modes based on one or more of the at least one system characteristic.

12. The power converter system of claim 11, wherein the plurality of operating modes includes a parallel operating mode and a cascaded operating mode.

13. The power converter system of claim 1, wherein the converter control system is configured to determine the at least one system characteristic at predetermined intervals and, wherein, in response to a change in the at least one system characteristic determined at one of the predetermined intervals, the converter control system determines an updated set of one of more of the plurality of N-phase power converters to be enabled power converters.

14. The power converter system of claim 1, wherein the converter control system is configured to:
determine an N-phase power converter of the set of one or more of the plurality of N-phase power converters is in a fault state;
determine an updated set of one of more of the plurality of N-phase power converters to be enabled power converters, wherein the updated set does not include the N-phase power converter that is in the fault state; and
drive the power switching elements of the enabled power converters to convert DC power received via the DC terminals to AC power to output via the AC terminals.

15. The power converter system of claim 1, wherein the AC terminals are coupled to at least one selected from a group of an external power network and an AC motor, and wherein the DC terminals connect to the battery via a DC/DC power converter comprising power switching elements connected to the DC terminals, and an LC filter connected to the power switching elements and to battery terminals.

16. The power converter system of claim 1, wherein the plurality of N-phase power converters includes a dedicated charging power converter.

17. The power converter system of claim 1, wherein the determination of the N-phase power converters to be included in the set of one or more N-phase power converters is made based on a round-robin selection algorithm.

18. A method of power conversion for an electric vehicle, the method comprising:
determining at least one system characteristic of a power converter system, the power converter system including direct current (DC) terminals to connect to a battery, alternating current (AC) terminals to connect to a motor, and a plurality of N-phase power converters, each N-phase power converter including, for each of N phases of the N-phase power converter, power switching elements connected to the DC terminals and including an LC filter connected to the power switching elements and to the AC terminals;
determining, based on the at least one system characteristic, a first set of one or more of the plurality of N-phase power converters to be enabled power converters; and
driving the power switching elements of the enabled power converters to convert DC power received via the DC terminals to AC power to output via the AC terminals.

19. The method of claim 18, further comprising:
selecting, based on the at least one system characteristic, an operating mode of a plurality of operating modes of the N-phase power converters, the plurality of operating modes including a parallel mode and a cascading mode,
wherein the selection of the operating mode is performed based on the at least one system characteristic, and
wherein driving the power switching elements includes implementing the selected operating mode.

20. The method of claim 19, wherein the plurality of operating modes includes a parallel operating mode and a cascaded operating mode.

21. The method of claim 18, further comprising:
determining an updated system characteristic of the power converter system; and
determining, based on the updated system characteristic, a second set of N-phase power converters of the plurality of N-phase power converters to be enabled power converters.

22. The method of claim 21, wherein the updated system characteristic of the power converter system are indicative of an increased power demand and wherein the second set of N-phase power converters includes a higher number of N-phase power converters than the first set of one or more of the plurality of N-phase power converters.

23. The method of claim 21, wherein the updated system characteristic of the power converter system are indicative of a decreased power demand and wherein the second set of N-phase power converters includes a lower number of N-phase power converters than the first set of one or more of the plurality of N-phase power converters.

24. The method of claim 18, wherein the first set of N-phase power converters include a first N-phase power converter and a second N-phase power converter, and wherein driving the power switching elements of the second N-phase power converter does not start until the first N-phase power converter reaches a first load threshold.

25. The method of claim 18, wherein the at least one system characteristic includes at least one selected from a group of:
a thermal flux of at least one of the first set of one or more N-phase power converters;
a throttle signal;
a power output at the AC terminals,
a load across each N-phase power converter of the plurality of N-phase power converters, a power characteristic at each N-phase power converter of the plurality of N-phase power converters, and
a usage parameter of one or more of the N-phase power converter.

26. The method of claim 18, further comprising:
determining the at least one system characteristic at predetermined intervals; and
in response to a change in the at least one system characteristic determined at one of the predetermined intervals, determining an updated set of one of more of the plurality of N-phase power converters to be enabled power converters.

27. The method of claim 18, wherein the determination of the first set of one or more N-phase power converters based on the at least one system characteristic includes determining the first set based on a round-robin selection algorithm.

28. A non-transitory computer readable medium, comprising instructions that, when executed, cause a computer to:
determine at least one system characteristic of a power converter system, the power converter system including direct current (DC) terminals to connect to a battery, alternating current (AC) terminals to connect to a motor, and a plurality of N-phase power converters, each N-phase power converter including, for each of N phases of the N-phase power converter, power switching elements connected to the DC terminals and including an LC filter connected to the power switching elements and to the AC terminals;
determine, based on the at least one system characteristic, a first set of one or more of the plurality of N-phase power converters to be enabled power converters; and
drive the power switching elements of the enabled power converters to convert DC power received via the DC terminals to AC power to output via the AC terminals.

29. The computer readable medium of claim 28, further comprising:
selecting, based on the at least one system characteristic, an operating mode of a plurality of operating modes of the N-phase power converters, the plurality of operating modes including a parallel mode and a cascading mode,
wherein the selection of the operating mode is performed based on the at least one system characteristic, and
wherein driving the power switching elements includes implementing the selected operating mode.

30. The computer readable medium of claim 29, wherein the plurality of operating modes includes a parallel operating mode and a cascaded operating mode.

31. The computer readable medium of claim 28, further comprising:
determining updated system characteristic of the power converter system; and
determining, based on the updated system characteristic, a second set of N-phase power converters of the plurality of N-phase power converters to be enabled power converters.

32. The computer readable medium of claim 31, wherein the first set of N-phase power converters include a first N-phase power converter and a second N-phase power converter, and wherein driving the power switching elements of the second N-phase power converter does not start until the first N-phase power converter reaches a first load threshold.

33. The computer readable medium of claim 28, further comprising:
determining the at least one system characteristic at predetermined intervals; and
in response to a change in the at least one system characteristic determined at one of the predetermined intervals, determining an updated set of one of more of the plurality of N-phase power converters to be enabled power converters.

34. The computer readable medium of claim 28, wherein the determination of the first set of one or more N-phase power converters based on the at least one system characteristic includes determining the first set based on a round-robin selection algorithm.
